(19) United States
(12) Patent Application Publication
(10) Pub. No.: US 2026/0093680 A1
(43) Pub. Date: Apr. 2, 2026

(54) GENERATING AND POPULATING DATA-LINK TREES FROM RELATIONSHIP CLUSTERS

(71) Applicant: Ancestry.com DNA, LLC, Lehi, UT (US)

(72) Inventors: Ross Eugene Curtis, Cedar Hills, UT (US); Donald Bernard Curtis, Highland, UT (US); Milos Pavlovic, Sandy, UT (US); Eugene David Greenwood, Orem, UT (US); Chaozhong Liu, Houston, TX (US); Ameen Eetemadi, Woodland, CA (US); Filip Kos, Sierra Madre, CA (US); Angelia Bush, Salt Lake City, UT (US); Kelly McCloy Becker, Salt Lake City, UT (US)

(21) Appl. No.: 19/334,627

(22) Filed: Sep. 19, 2025

Related U.S. Application Data
(60) Provisional application No. 63/701,329, filed on Sep. 30, 2024.

(51) Int. Cl. G06F 16/22; G06F 16/28

(52) U.S. Cl. CPC G06F 16/2246; G06F 16/285

(57) ABSTRACT

The present disclosure is directed toward systems, methods, and non-transitory computer-readable media for generating a matched-data-link tree defining relationships among individuals according to genetic data. For example, the disclosed systems can determine matches of matches using a novel matching database structure. The disclosed systems encode integers based on data matches of a data identifier and populate a match database with the integers. Correlating data match integers for a data identifier with data match integers for data matches, the disclosed systems generate matches of matches. The disclosed systems can generate relationship clusters from matches of matches. For example, the disclosed systems compare sets of data matches to discover groups of data matches with stronger data-match levels. The disclosed systems can generate and populate a data-link tree from a relationship cluster. In addition, the disclosed systems can merge one or more data-link trees into a single data-link tree.

### CROSS REFERENCE TO RELATED APPLICATIONS

The present application claims priority to and the benefit of U.S. Provisional Patent Application No. 63/701,329, filed on Sep. 30, 2024. The aforementioned application is hereby incorporated by reference in its entirety.

### BACKGROUND

Genealogical databases can include billions of data records for generating data-tree structures, conducting data-identifier origination research, and identifying content items relating to related data identifiers, including data identifiers with antecedent data links. In the field of genealogical data research, existing systems can organize genealogical records in stratified data structures, such as data-tree structures representing the relatedness among individuals according to data within the genealogical records. Despite the benefits and utility of these record-based data-tree structures, engineering efforts of existing systems have nevertheless sought additional database organization through generating a different type of data-tree structure that organizes individuals and their relationships according to genetic data, such as data identifiers or genotypes defined by data markers (e.g., deoxyribonucleic acid (DNA)). However, existing systems exhibit a number of impediments, particularly in relation to computational efficiency and accuracy, that prevent such functionality and/or render their attempts impractical if not impossible.

As just suggested, certain existing data-match determination systems are inefficient. To elaborate, existing systems often consume excessive amounts of computational resources, such as processing power and memory, in storing and utilizing genetic data. For instance, some existing systems generate and maintain genetic databases that are query-able for determining immediate data matches among data identifiers (e.g., individuals). However, while existing databases can be effective for determining immediate matches (e.g., direct matches of a data identifier), they are very large and store vast amounts of data tailored for other genetic analyses, rendering them inefficient and impractical to use for determining matches beyond immediate matches (e.g., matches of matches). Indeed, due to their optimized task-specific nature, some genetic databases are spread across many server shards (e.g., 50 or more) which are not only computationally expensive to query (and the expense compounds over many queries to determine matches of matches) but also slow to update for new genetic data. In addition, existing systems attempt to generate data-link trees by brute force, assembling nodes at random into a data-link tree and repeatedly perturbing the data-link tree with random perturbations in an effort to discover more accurate placement of nodes. The process of repeatedly perturbing the data-link tree and comparing results is time-consuming and requires exponentially greater computational resources as data-link trees increase in size.

In addition to their inefficiencies, many existing systems are inaccurate. Specifically, while some existing systems have developed to generate clusters representing data matches descending from common antecedent data identifiers, such existing systems generate these clusters inaccurately. For example, existing systems use inaccurate and/or incomplete clustering algorithms that rely on user input to set clustering parameters. Because of the inaccuracies and variation inherent in relying on user input to set clustering parameters, the clustering algorithms of existing systems are unreliable to use as a basis for building a stratified structure of data links across an entire database of (millions of) data identifiers. Inaccurate predictions can be worse, in many cases, than no prediction at all, as an inaccurate prediction can sully a user's experience with and confidence in a product, thereby depriving them of further opportunities for meaningful emotional engagement and enrichment from the discoveries that can be made from accessing and exploring such data. In addition, existing systems propagate inaccurate data match clusters into inaccurate data-link trees by assembling edges and nodes at random

Beyond their inefficiencies and inaccuracies, some existing systems are also time-consuming to implement and require fixes while in a live production environment. For example, the genetic databases of many existing systems are often tailored for low-level data constructs or environments (e.g., L1) within a cloud-based computing platform (e.g., Amazon Web Services). Using these low-level data constructs not only prevents bundling resources for more efficient computation, but low-level data constructs are also live production environments. Thus, without validation methods and measures to prepare and troubleshoot a system prior to implementation in a production environment, databases spun up in lower levels of a cloud computing platform may require more time to implement and troubleshoot—including immediate priority fixes—while presenting less accurate data to users.

### BRIEF DESCRIPTION OF THE DRAWINGS

The detailed description provides one or more embodiments with additional specificity and detail through the use of the accompanying drawings, as briefly described below.

FIG. 1 illustrates a schematic diagram of an example system environment for implementing a matched-data-link system in accordance with one or more embodiments.

FIG. 2 illustrates an example diagram of determining matches of matches utilizing a match database and a match calculator in accordance with one or more embodiments.

FIG. 3 illustrates an example diagram of a process for generating matches of matches from a data identifier utilizing meiosis matches and integer encoding in accordance with one or more embodiments.

FIG. 4 illustrates an example diagram depicting a relationship cluster generated from data-match levels for a data identifier in accordance with one or more embodiments.

FIG. 5A illustrates an example diagram of a process for generating a simulated dataset utilizing tunable simulation parameters in accordance with one or more embodiments.

FIG. 5B illustrates an example diagram depicting data-match levels from simulated data for a data identifier based on relationship in accordance with one or more embodiments.

FIG. 5C illustrates a set of example charts depicting simulated birth years across generations of simulated data identifiers in accordance with one or more embodiments.

FIG. 6A illustrates an example diagram of a process for determining relationship clusters in accordance with one or more embodiments.

FIG. 6B illustrates an example diagram of a process for generating and merging data-link trees to create a final tree.

FIG. 6C illustrates an example diagram of generating and populating a data-link tree from a relationship cluster in accordance with one or more embodiments.

FIGS. 6D-6E illustrate example diagrams of selecting a data identifier from a relationship cluster for placement in a data-link tree.

FIG. 6F illustrates example diagrams depicting prediction accuracy for data links using different models for selecting data identifiers.

FIG. 6G illustrates an example diagram of a process for generating candidate data-link trees.

FIG. 6H illustrates an example diagram of a data-link tree perturbation

FIG. 6I illustrates an example diagram of a process for filtering one or more candidate data-link trees.

FIG. 6J illustrates example diagrams of a confusion matrix depicting data-match level calling errors.

FIG. 7 illustrates an example diagram of a process for combining data-link-tree structures in accordance with one or more embodiments.

FIG. 8 illustrates an example diagram of a process for traversing ahnentafel structures to determine matching probabilities of probands.

FIG. 9 illustrates an example block diagram of an architecture of an example computing server in accordance with one or more embodiments.

FIG. 10 illustrates an example flowchart of a series of acts for determining matches of matches in accordance with one or more embodiments.

FIG. 11 illustrates an example flowchart of a series of acts for generating relationship clusters from matches of matches in accordance with one or more embodiments.

FIG. 12 illustrates an example flowchart of a series of acts for generating a simulation dataset for validating clusters in accordance with one or more embodiments.

FIG. 13 illustrates an example flowchart of a series of acts for determining likely tree configurations by generating and populating a data-link-tree structure in accordance with one or more embodiments.

FIG. 14 illustrates an example flowchart of a series of acts for combining data-link-tree structures in accordance with one or more embodiments.

FIG. 15 illustrates an example flowchart of a series of acts for utilizing a traversal algorithm to determine probabilities of nodes in different tree structures representing common individuals in accordance with one or more embodiments.

FIG. 16 illustrates a block diagram of an exemplary computing device in accordance with one or more embodiments.

FIG. 17 illustrates an example environment of a genealogical-data system including a matched-data-link system in accordance with one or more embodiments.

### SUMMARY

This disclosure describes one or more embodiments of systems, methods, and non-transitory computer-readable storage media that provide benefits and/or solve one or more of the foregoing and other problems in the art. In particular, the disclosed systems introduce a unique approach to generating a record-agnostic data-tree structure from genetic data. For example, the disclosed systems can generate a matched-data-link tree defining relationships among data identifiers according to genetic data. As part of building the matched-data-link tree, the disclosed systems can determine matches of matches using a novel matching database structure. The disclosed systems can generate relationship clusters from matches of matches. In some cases, the disclosed systems can generate a simulation dataset for validating clusters and other genetic evaluations. Additionally, the disclosed systems can determine likely tree configurations by generating and populating data-link tree structures for individual data identifiers. Further, the disclosed systems can combine data-link tree structures into a matched-data-link tree. The disclosed systems can also traverse the matched-data-link tree using a traversal algorithm to determine probabilities of nodes in different tree structures representing common individuals.

### DETAILED DESCRIPTION

This disclosure describes one or more embodiments of a matched-data-link system that can generate a matched-data-link tree (e.g., a data tree with nodes representing genetic data or DNA of connected individuals) defining relationships among individuals according to genetic data. Indeed, the matched-data-link system can generate a matched-data-link tree made up of nodes representing data identifiers (e.g., individuals) and edges representing relationships between them, where the relationships are based on genetic similarities between genotypes of data identifiers. As part of generating (and validating) a matched-data-link tree, the matched-data-link system can perform several processes or functions, including: 1) determining matches of matches for a data identifier, 2) generating relationship clusters from the matches of matches, 3) generating a simulation dataset to validate the relationship clusters (and other genetic evaluations, including matches of matches), 4) determining likely data-link tree structures for data identifiers, 5) combining data-link tree structures across data identifiers into a matched-data-link tree, and 6) traversing the matched-data-link tree using a traversal algorithm.

As just mentioned, the matched-data-link system can determine matches of matches for a data identifier. To elaborate, the matched-data-link system can determine a data match for a particular data identifier representing an individual by analyzing genomes or genotypes to identify and compare data variants (e.g., single nucleotide polymorphisms (SNPs)) in an identity-by-descent (IBD) approach. From the matches of the data identifier, the matched-data-link system can further determine matches of those matches. To facilitate this process, the matched-data-link system generates, maintains, and utilizes a specialized match database tailored for determining matches of matches that greatly improves speed and efficiency over existing genetic databases. In some embodiments, the matched-data-link system generates the match database using an integer encoding process to efficiently encode data identifiers for fast referencing and querying matches of matches. Indeed, to determine a match of a match, the matched-data-link system can access, within the match database, matches encoded as integers in a row for a data identifier and can further query the match database to identify the rows corresponding to each of the integer matches, where each row contains its own list of additional integers representing the matches of the initial integer matches.

As mentioned, the matched-data-link system can also generate relationship clusters from matches of matches. In particular, the matched-data-link system can use a specialized and unique relationship clustering algorithm to process matches of matches and group them into clusters indicating individuals that likely descend from common antecedent data identifiers. The relationship clustering algorithm can include filtering out matches at specified data-match levels (e.g., meiosis levels) and applying custom relatedness thresholds (e.g., centimorgan or cM thresholds) to cluster genomes or genotypes in relation to a particular data identifier or proband. Additional detail regarding the relationship clustering algorithm is provided below with reference to the figures.

As also mentioned, the matched-data-link system can generate and utilize a unique simulation dataset for validating relationship clusters, matches of matches, and other genetic evaluations. To elaborate, the matched-data-link system can generate the simulation dataset by augmenting existing genetic data (e.g., genomes or genotypes) stored for data identifiers. To maintain plausibility and accuracy in relation to real-world populations (for accurate testing and validation), the matched-data-link system can incorporate (and set values for) certain simulation parameters that are reflected within known populations, such as a cousin marriage rate, a cross-generation relationship rate, and a half-sibling rate (sometimes referred to as a reformed family rate). Based on these simulation parameters, the matched-data-link system can generate simulated data identifiers by augmenting existing genotypes using simulated admixture over multiple (e.g., 5 to 10) generations. As part of generating the simulated data identifiers, the matched-data-link system can also simulate couples having somewhere within a range (e.g., 1 to 8) of children, while also replicating one or more genomes or genotypes according to a statistical occurrence of identical twins in known populations (e.g., 0.4%). Further, the matched-data-link system can generate metadata for surnames and birth years to associate with the simulated data identifiers to include within the simulation dataset.

In addition, as noted above, the matched-data-link system can determine likely pedigree structures or tree configurations for data identifiers. For example, the matched-data-link system can determine or identify a set of related individuals from a relationship cluster (as generated using a relationship clustering algorithm). From the set of related individuals, the matched-data-link system can determine factors or metrics corresponding to the relatedness of the individuals, including data-match levels (e.g., meiosis levels), genomic data for specific data variants (e.g., SNPs) or haplotypes, and familial relationship data indicating familial relationships (e.g., father, mother, uncle, grandmother). Using these data, the matched-data-link system can determine probabilities or likelihoods for various data-link tree structures corresponding to, fitting, or representing a relationship cluster. In some cases, the matched-data-link system can select a data-link tree structure for an individual (e.g., a data identifier) or for a relationship cluster as a structure with a highest (or at least a threshold) structure probability to represent or organize a relationship cluster corresponding to the individual. The matched-data-link system can also use these data to determine location probabilities of individuals (represented by data identifiers) belonging in particular nodes or structure locations within the selected pedigree structure.

As further mentioned above, the matched-data-link system can generate a matched-data-link tree from one or more pedigree structures. More particularly, the matched-data-link system can combine multiple pedigree structures for various individuals. For instance, the matched-data-link system can determine pedigree structures corresponding to different individuals in a genealogy database. From these pedigree structures, the matched-data-link system can form a matched-data-link tree that merges nodes of the discrete structures according to various probabilities. In some cases, the matched-data-link system combines pedigree structures by determining, from genetic data, familial relationship data, and structure organization, probabilities of nodes within structures representing common individuals (e.g., the same people). The matched-data-link system can thus combine data-link tree structures by merging nodes for common individuals.

Additionally, as mentioned above, the matched-data-link system can perform a traversal of a matched-data-link tree. To elaborate, the matched-data-link system can use a unique traversal algorithm tailored to the structure of a matched-data-link tree. In some cases, the traversal algorithm involves generating ahnentafel structures for data identifiers (or probands). Within an ahnentafel structure, the matched-data-link system determines numeric identifiers signifying unique or archetypal relationships to a proband (e.g., 2=father, 3=mother). In some cases, the matched-data-link system further determines (from genetic data, familial relationship data, and other structural data defining the matched-data-link tree data) probabilities associated with the numeric identifiers, where a probability represents a measure or a degree of confidence that the individual represented by the numeric identifier has the corresponding relationship with the proband. The traversal algorithm can also include comparing ahnentafel structures to determine matching probabilities across them, where a matching probability represents a measure or degree of confidence that an individual represented one a numeric value in one ahnentafel structure is the same individual represented by another numeric value in a different ahnentafel structure.

As suggested above, the matched-data-link system can provide improvements or advantages over existing historical content systems. For example, the matched-data-link system can improve computational efficiency over prior systems. Compared to existing systems that waste computational resources with databases storing large amounts of data spread over many server shards, the matched-data-link system generates and maintains a much smaller (omitting various data, such as test GUIDs or Globally Unique Identifiers included in other databases), more efficient match database that is operable on a single shard. Indeed, the matched-data-link system generates a match database using an integer encoding process to generate a table of rows representing data identifiers (or individuals), where each row is defined by an integer and is populated by additional integers representing data matches of the individual represented by the row-specific integer. Additionally, as a result of an efficient match-of-match determination algorithm that relies on less stored data than match algorithms of prior systems, the match database stores a particular subset of data matches (e.g., meiosis matches M0-M9, ignoring or omitting M10), reducing storage capacity by about 90% compared to previous systems. Additionally, within the match database, the matched-data-link system structures the storage of the data matches into two data segments, one for M0-M8 matches and another for M9 matches, for independent memory access and retrieval. Thus, using the match database, the matched-data-link system can perform updates faster and more efficiently than prior systems. Additionally, the matched-data-link system can perform match-of-match determinations, a task which is impossible or at least extremely computationally expensive and slow using databases of prior systems. Further, the matched-data-link system can generate data-link trees node by node based on data-match levels of nodes of a relationship cluster. In this, the matched-data-link system constructs data-link trees more quickly than prior systems which randomly assemble nodes and edges in bulk and perturb the data-link tree seeking more accurate node placement.

In addition to improving computational efficiency, the matched-data-link system can also improve accuracy. For example, the matched-data-link system can more accurately generate relationship clusters than prior systems. As opposed to prior systems that rely on user input to set parameters for clustering algorithms (and which are consequently inconsistent and unreliable, being, as they are, subject to human bias, error, and inexperience with the inner workings of the system), the matched-data-link system uses a more sophisticated relationship clustering algorithm to generate relationship clusters. Researchers have demonstrated the accuracy and reliability of the relationship clustering algorithm in generating relationship clusters for data identifiers. Not only is the relationship clustering algorithm more accurate than clustering of prior systems, but it is also more efficient. Indeed, the matched-data-link system can cache data matches (e.g., from relationship prediction models) in memory for fast access (for generating clusters and/or using in other downstream processes), as opposed to algorithms of prior systems that require storing match data in slower storage for repeated queries. Further, the matched-data-link system generates more accurate data-link trees from the more accurate relationship clusters by iteratively adding a single node based on a data-match level with an already placed node.

Beyond improving efficiency and accuracy, embodiments of the matched-data-link system also improve pre-production validation over prior systems. While some existing systems are prone to time-consuming implementations requiring troubleshooting and adjusting live data by building models in low-level cloud computing constructs, such as an L1 environment for application production (e.g., a level-1 environment), the matched-data-link system utilizes a more efficient match database that is executable on higher-level configurations, such as L2 (e.g., a non-production cloud computing environment for testing). Thus, the matched-data-link system can implement, adjust, and validate the algorithms in a non-production environment to perform operations to generate clusters, simulation data, matched-data-link trees, and perform other functions described herein. By validating the algorithms in a non-production environment before implementing in a live production environment, the matched-data-link system can implement algorithms quicker and more accurately than other methods.

As illustrated by the foregoing discussion, the present disclosure utilizes a variety of terms to describe features and benefits of the matched-data-link system. Additional detail is hereafter provided regarding the meaning of these terms as used in this disclosure. For example, as used herein, the term “matched-data-link tree” refers to a data structure or a construct made up of nodes and edges, where the nodes represent data identifiers or individuals (as extracted or generated by genetic IBD testing) and the edges connect the nodes, representing relationships between the data identifiers. For example, a matched-data-link tree can represent genetic relatedness of data identifiers across an entire genealogical database of a genealogical-data system, including millions or billions of nodes and edges. In some cases, a matched-data-link tree can include or correspond to a visualization of an underlying structure that defines and depicts genetic (e.g., DNA-based) relationships among data identifiers or individuals.

As used herein, the term “data identifier” refers to a discrete piece (e.g., string) of information or data that uniquely represents or characterizes a specific data point, entity, and/or feature within or across a dataset. In particular, a data identifier can be extracted from, or represent, genetic, genomic, and/or genealogical data or information that defines the genetic composition of an individual at a particular allele on a chromosome or across a dataset or across a grouped set of such data. For example, a data identifier can refer to (or represent) a nucleotide sequence—such as a genome, a genotype, or a haplotype, a reconstructed genome, a partially reconstructed genome, (or a combination thereof)—at a particular allele on a chromosome or across a grouped set of such data. A data identifier, in some embodiments, corresponds to one or two phased haplotypes inherited respectively from the parents of a corresponding individual. In some cases, a data identifier refers to or includes a “proband” which represents a subject or a target individual for a genetic evaluation, tree, or data structure. Relatedly, as used herein, a “related data identifier” refers to a data identifier of an individual related to a target individual or a proband.

In addition, as used herein, the term “data match” (or sometimes “meiosis match”) refers to a genetic match between two individuals based on the inheritance of DNA segments that have undergone meiosis. For example, a meiosis match can signify that two individuals (or data identifiers) share a certain amount of identical DNA due to inheritance from a common antecedent data identifier (e.g., a most recent common ancestor or MRCA). In some cases, the amount and length of shared DNA segments informs the degree of relatedness between individuals or data identifiers. In certain embodiments, a meiosis match or a data match can refer to or be represented by a matched-data-link tree edge that links nodes in a matched-data-link tree, signifying a match or a relationship linking two data identifiers or individuals.

As used herein, the term “data link” refers to a linkage between two entities defined by similarities or comparisons of their data identifiers. A data link can refer to a genetic or genealogical relationship between two entities (e.g., individuals), such as specific familial relationships or familial ties (e.g., parent-child, siblings, cousins) or other relevant associations. Relatedly, as used herein, an “antecedent data link” refers to a genetic relationship from a target individual to a precursor entity or an antecedent individual (e.g., an ancestor). As used herein, a “predicted data link” is a data link that the matched-data-link system predicts based on information about the entities.

In one or more embodiments, a data match can have a corresponding “data-match level” (or “meiosis level”) that represents a number of (predicted) edges or degrees of separation (e.g., meiosis events) separating two data identifiers. For instance, an M1 match (or an M1 relationship) represents a data match that is separated by one meiosis event (e.g., a parent-child relationship). In addition, an M2 match (or an M2 relationship) represents a data match that is separated by two meiosis events (e.g., a full sibling relationship). An M3 match (or an M3 relationship) represents a data match separated by three meiosis events, such as a half-sibling, grandparent/grandchild, or avuncular relationship. An M4 match (or M4 relationship) refers to a data match separated by four meiosis events, such as a first cousin, great grandparent to grandchild, half avuncular, or great avuncular relationship. An M5 match (or M5 relationship) represents a data match separated by five meiosis events, such as first cousin once removed, half first cousin, or half great avuncular relationship. An M6 match (or M6 relationship) represents a data match separated by six meiosis events, such as a second cousin, first cousin twice removed, or half first cousin once removed relationship. An M7 match (or M7 relationship) represents a data match separated by seven meiosis events, such as a second cousin once removed, half second cousin, first cousin thrice removed, or half first cousin once removed relationship. An M8 match (or M8 relationship) represents a data match separated by eight meiosis events, such as a third cousin, or a second cousin twice removed relationship. An M9 match (or an M9 relationship) represents a data match separated by nine meiosis events, such as third cousin once removed, or second cousin thrice removed relationship. An M10 match (or an M10 relationship) represents a data match separated by ten meiosis events.

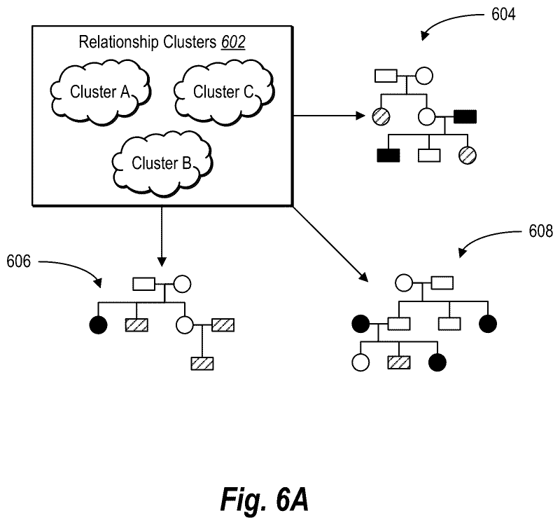

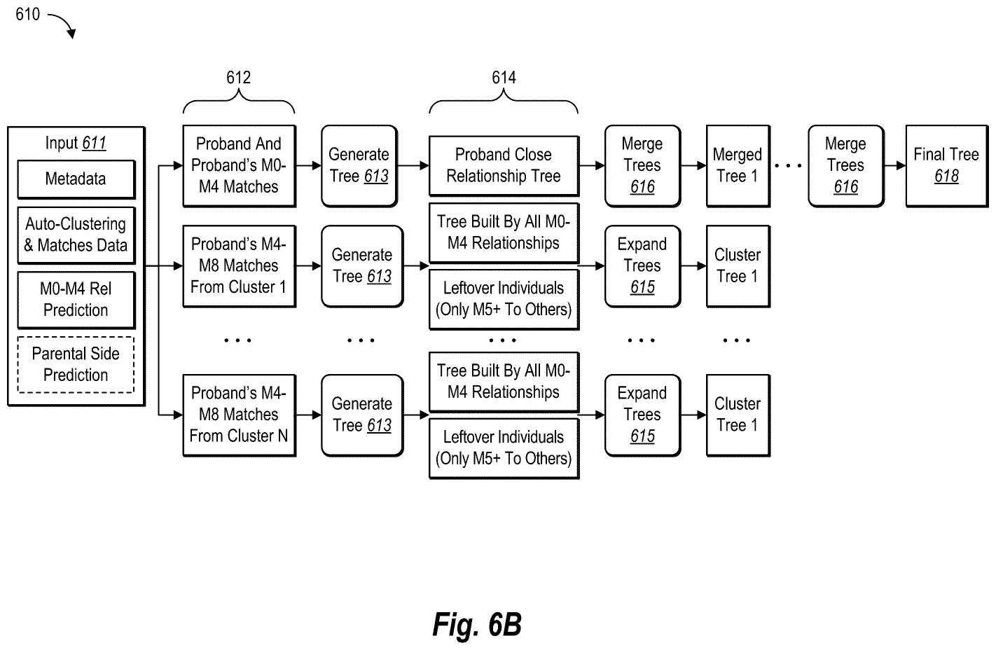

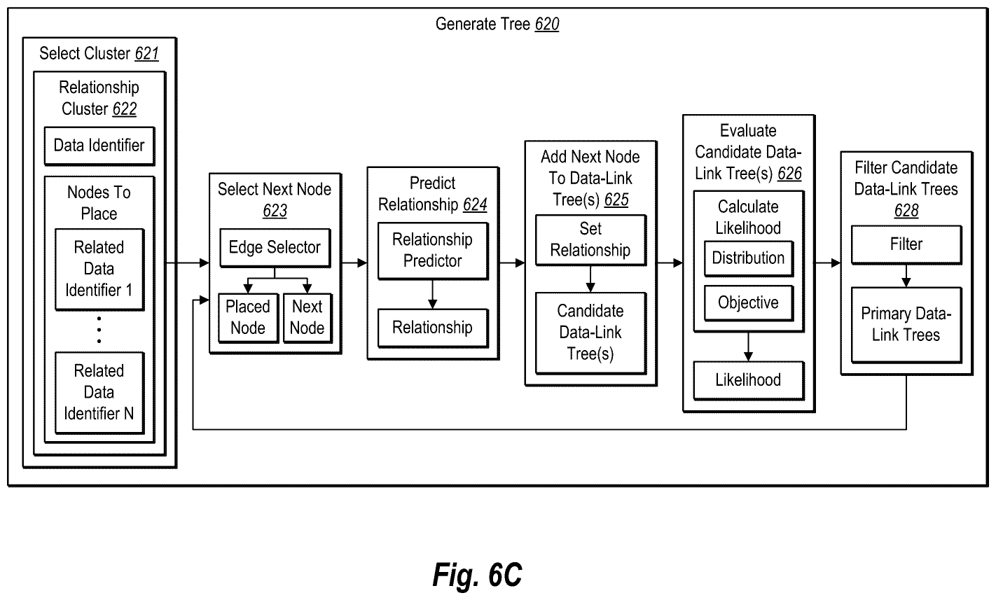

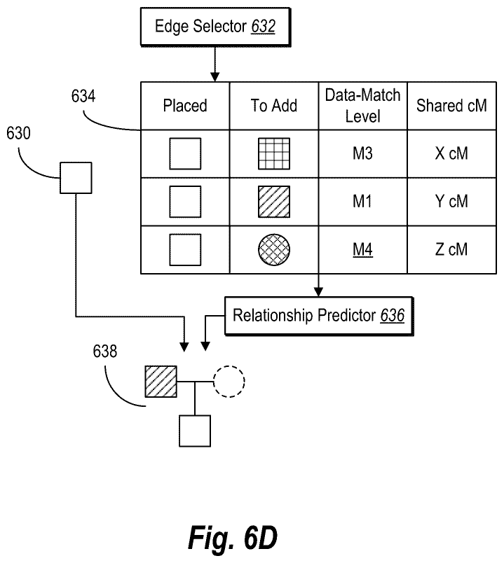

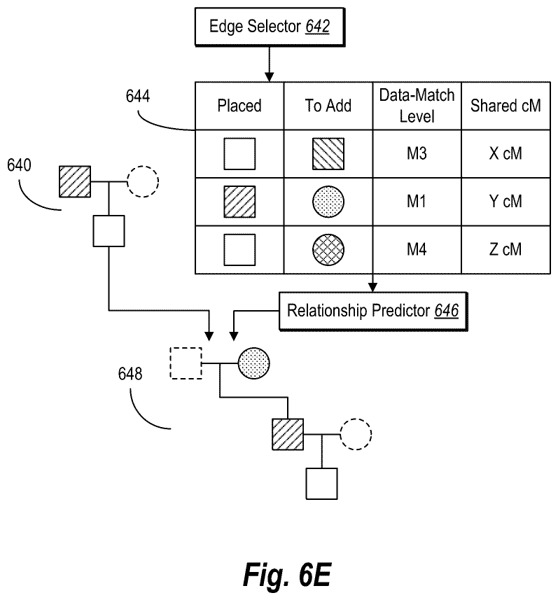

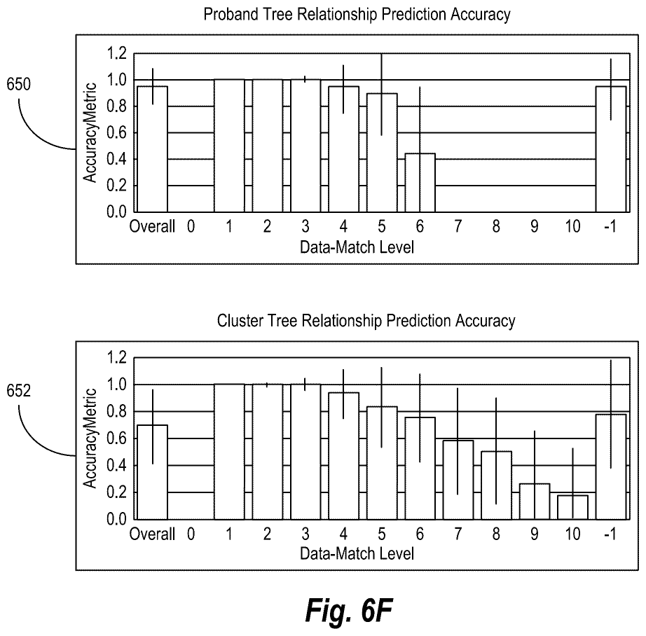

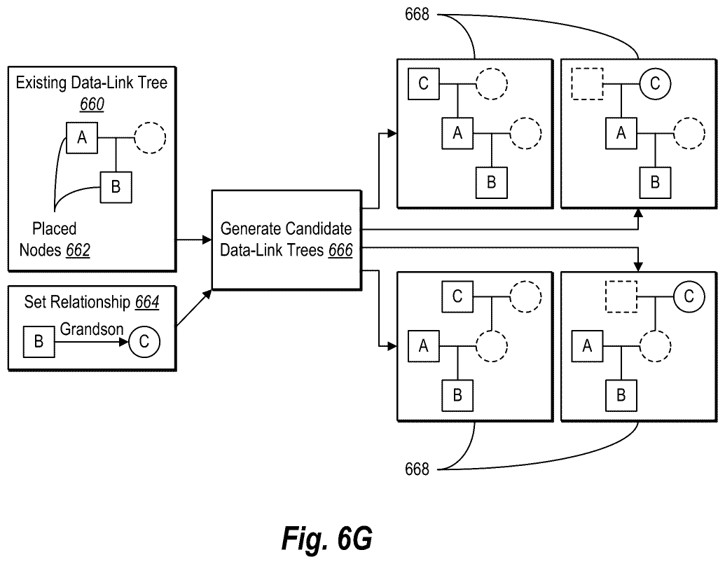

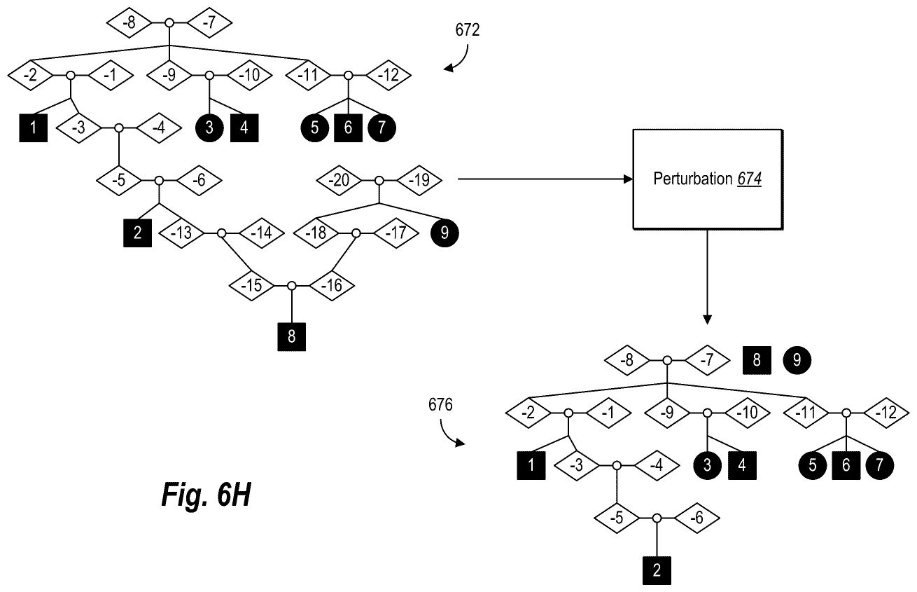

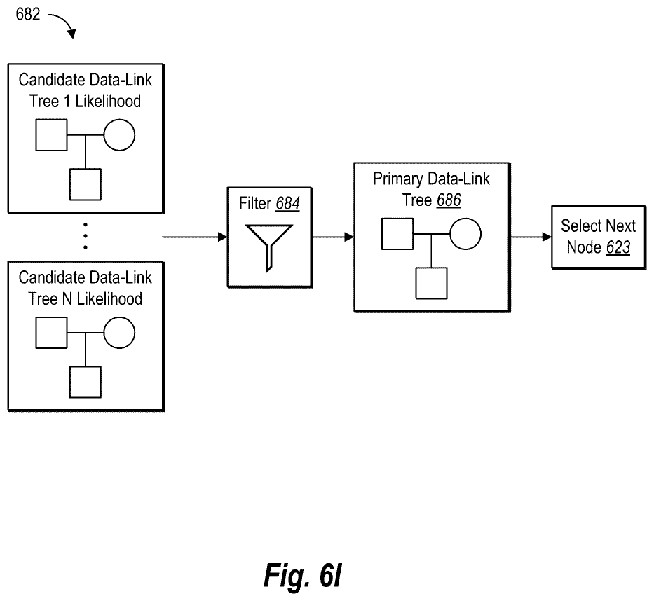

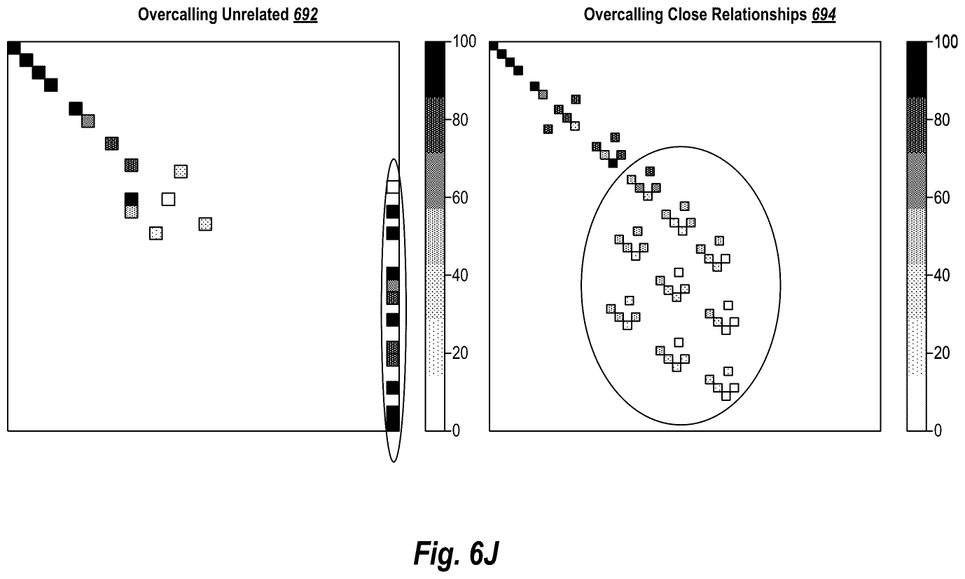

Relatedly, as used herein, the term “data-match value” refers to a quantification of the likelihood that a predicted data match or a predicted data link (or a series of predicted data matches or predicted data links, e.g., a candidate data-link tree) corresponds to the actual relationship(s) of the data identifiers. For example, a higher data-match value corresponds to a higher likelihood that the predicted data link represents the true relationship between data identifiers. In some embodiments, the data-match value is calculated using a likelihood calculation methodology. For instance, the matched-data-link system can determine the data-match value by performing an objective calculation (as described in below in FIG. 6C) by using the negative log likelihood of a data match based on a distribution methodology. In one or more embodiments, different distribution methodologies may result in different data-match values for the same data match or data link. The matched-data-link system may also calculate a data-match value using other methods to classify and rank a data match or data link by likelihood.

As noted above, in some embodiments, the matched-data-link system generates relationship clusters using relationship prediction models and a relationship clustering algorithm. As used herein, the term “relationship cluster” refers to a cluster or group of data identifiers (or individuals) with at least a threshold probability of sharing DNA through a common antecedent data identifier. For example, a relationship cluster can include a group of data identifiers that are (above a threshold probability of being) data matches with one another. In some cases, a relationship cluster can refer to a group of meiosis matches of a particular data-match level (e.g., M3 matches in an M3 cluster) or can refer to a group of data matches across various data-match levels. In one or more embodiments, the matched-data-link system generates a relationship cluster using a “relationship clustering algorithm” which refers to a set of one or more computer functions, processes, or subroutines that are executable to cluster data identifiers. A relationship clustering algorithm can include specific processes executed in a precise sequence based on predefined, coded parameters.

Relatedly, as used herein, the term “relationship prediction model” refers to a computer model or set of functions that generates or predicts data matches between individuals or data identifiers. For example, a relationship prediction model can be designed and structured to generate or predict relationships (and corresponding probabilities) at a particular data-match level (e.g., meiosis level). In certain embodiments, a relationship prediction model can include an M1 model, an M2 model, an M3 model, an M4 model, and so on for various data-match levels, where each level-specific model generations relationship predictions of data matches for its own data-match level. In some cases, a relationship prediction model includes a machine learning model, such as a neural network, that includes parameters tuned for predicting data matches (specific to a designated data-match level). In one or more embodiments, a relationship prediction model includes a model as described by Luong Ruiz et al. in U.S. patent application Ser. No. 18/101,075, titled RELATIONSHIP PREDICTION, filed Jan. 24, 2023, which is hereby incorporated by reference in its entirety.

In addition, as used herein, the term “machine learning model” refers to a computer algorithm or a collection of computer algorithms that automatically improve for a particular task through iterative outputs or predictions based on use of data. For example, machine learning model can utilize one or more learning techniques to improve in accuracy and/or effectiveness. Example machine learning models include various types of neural networks, decision trees, support vector machines, linear regression models, and Bayesian networks. In some embodiments, the model modification system utilizes a large language machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., search intent and/or content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training as described below, such a neural network may become a large language model that generates responses to prompts by interpreting prompt language, accessing additional data from content items, and executing functions indicated by prompts and/or content items.

In one or more embodiments, the matched-data-link system generates data-link tree structures for individuals or data identifiers. As used herein, the term “data-link tree structure” (or simply “data-link tree”) refers to data construct that represents the relationships and inheritance patterns among data identifiers (or individuals). For example, a data-link tree structure can be specific to a particular data identifier or individual and can store or include up to a threshold number of generations. In some cases, a data-link tree structure includes nodes and edges only for data identifiers and relationships having at least a threshold probability or confidence based on genetic data and/or other metrics from a relationship cluster (and/or a relationship prediction model).

In one or more embodiments, the term “candidate data-link tree” refers to a data-link tree representing a potential placement of a node in a data-link tree. For example, a set of candidate data-link trees can represent multiple potential placements of a node within a data-link tree, with each candidate data-link tree representing one possible placement. In one or more embodiments, the system generates a candidate data-link tree for each placement of a node within a data-link tree, based on the data link with a different node already placed in the data-link tree. For example, if the system determines that the node to be added is the grandparent of a node within the data-link tree, the system can generate up to four candidate data-link trees based on the four potential placements of the node as maternal grandmother, maternal grandfather, paternal grandmother, or paternal grandfather to the placed node. In some embodiments, the system selects the node to be placed from a relationship cluster.

In one or more embodiments, the term “primary data-link tree” refers to a data-link tree representing a candidate data-link tree selected based on data-match values. For instance, the system filters one or more candidate data-link trees based on data-match values and selects which candidate most likely reflects actual or true data links between nodes. In one or more embodiments, the system selects more than one candidate data-link tree and generates a primary data-link tree from each candidate data-link tree.

Additionally, in some embodiments, the matched-data-link system traverses a matched-data-link tree using a traversal algorithm that involves generating ahnentafel structures. As used herein, the term “ahnentafel structure” refers to a data structure defined by a genealogical numbering system that organizes and represents antecedent data identifiers of a proband (e.g., a subject data identifier or a subject individual). For instance, an ahnentafel structure for a proband can encode or represent the proband with the integer “1” and can represent every other data identifier in the structure with another numeric identifier (e.g., 2 for father, 3 for mother, 4 for father's father, 5 for father's mother, and so on).

Relatedly, the term “traversal algorithm” refers to a set or sequence of computer functions, processes, or subroutines that are executable to traverse a matched-data-link tree. For example, a traversal algorithm includes computer code defining processes to generate and compare ahnentafel structures across data identifiers to determine a probability of a numeric identifier in one ahnentafel structure matching (or representing the same individual) as a numeric identifier in another ahnentafel structure.

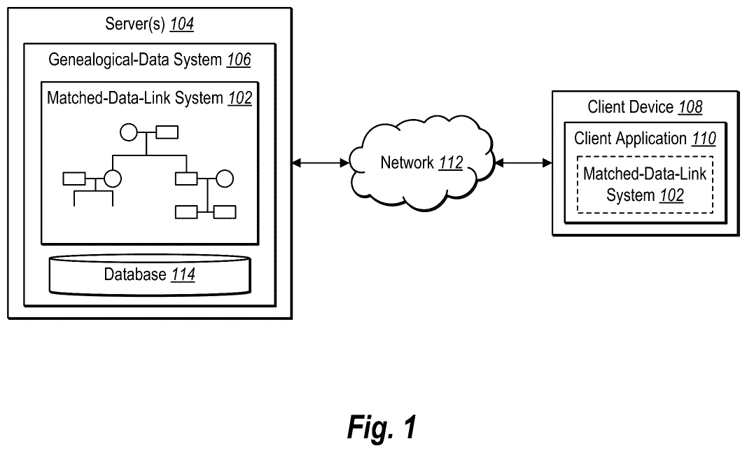

Additional detail regarding the matched-data-link system will now be provided with reference to the figures. For example, FIG. 1 illustrates a schematic diagram of an example system environment for implementing a matched-data-link system 102 in accordance with one or more implementations. An overview of the matched-data-link system 102 is described in relation to FIG. 1. Thereafter, a more detailed description of the components and processes of the matched-data-link system 102 is provided in relation to the subsequent figures.

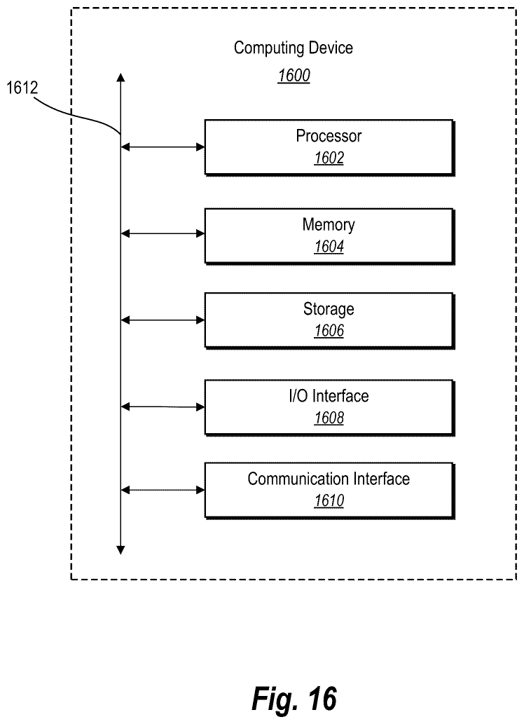

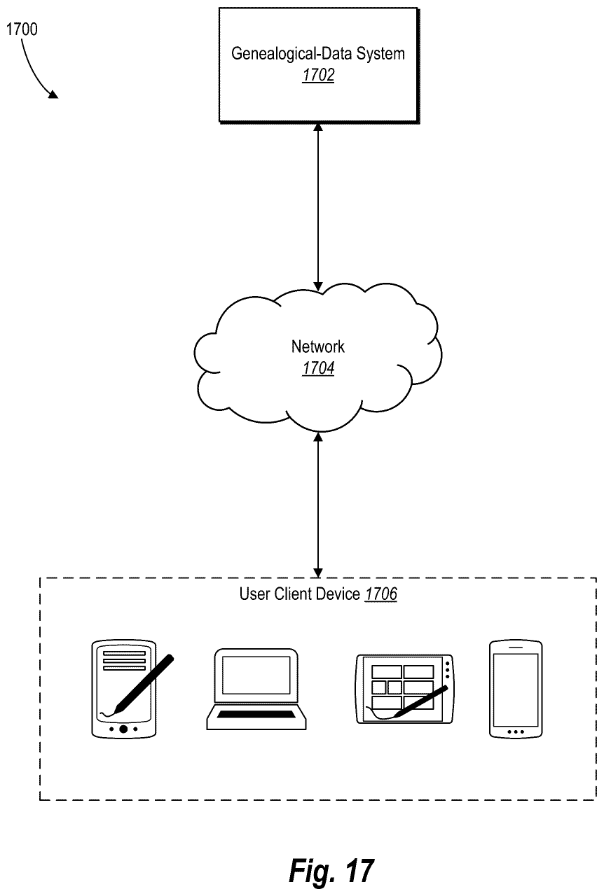

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIGS. 16-17.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 16-17. The client device 108 can communicate with the server(s) 104 and/or the database 114 via the network 112. For example, the client device 108 can receive user input from respective users interacting with the client device 108 (e.g., via the client application 110) to, for instance, search for, access, generate, modify, or share a genealogical content item and/or to interact with a data-tree structure or a content item via a graphical user interface of the genealogical-data system 106. In addition, the matched-data-link system 102 on the server(s) 104 can receive information relating to various searches for, or interactions with, genealogical content items, and/or user interface elements based on the input received by the client device 108.

As shown, the client device 108 can include a client application 110. In particular, the client application 110 may be a web application, a native application installed on the client device 108 (e.g., a mobile application, a desktop application), or a cloud-based application where all or part of the functionality is performed by the server(s) 104. Based on instructions from the client application 110, the client device 108 can present or display information, including a user interface such as a matched-data-link tree interface or some other graphical user interface, as described herein.

As illustrated in FIG. 1, the example environment also includes the server(s) 104. The server(s) 104 may generate, track, store, process, receive, and transmit electronic data, such as data identifiers, data matches, relationship clusters, simulation data, data-link tree structures, ahnentafel structures, various described algorithms, and/or matched-data-link tree data. For example, the server(s) 104 may receive data from the client device 108 in the form of a request to view or add new genetic data to a matched-data-link tree. In addition, the server(s) 104 can transmit data to the client device 108 in the form of a matched-data-link tree interface depicting a matched-data-link tree (including newly added genetic data). Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, cloud computing servers, application servers, communication servers, web-hosting servers, machine learning server, and other types of servers.

As shown in FIG. 1, the server(s) 104 can also include the matched-data-link system 102 as part of a genealogical-data system 106. The genealogical-data system 106 can communicate with the client device 108 to perform various functions associated with the client application 110 such as performing genetic evaluations, determining data matches, managing user accounts, managing genealogical data, managing data-tree structures, managing genealogical content items, and facilitating user interaction with, and sharing of, the data-tree structures and/or genealogical content items. Indeed, the genealogical-data system 106 can include a network-based cloud storage system to manage, store, and maintain genetic data and genealogical data user accounts. In some cases, the genealogical-data system 106 can utilize genealogical data across various content items and user accounts to generate and maintain a universal data-tree structure that reflects the relatedness or consanguinity between nodes corresponding to all user accounts and other individuals indicated by stored genealogical content items. In some embodiments, the matched-data-link system 102 and/or the genealogical-data system 106 utilize the database 114 to store and generate a universal matched-data-link tree defining data links in addition to the universal data-tree structure defining relationship extrapolated from various content items and other (non-genetic) data.

As further illustrated in FIG. 1, the genealogical-data system 106 includes a database 114 that stores genetic data, such as data identifiers, meiosis matches, relationship clusters, and other matched-data-link tree data. In particular, the matched-data-link system 102 stores the genetic data to generate a matched-data-link tree. For instance, the matched-data-link system 102 generates and maintains a match database (e.g., as part of or as a label for the database 114) that stores data match data, such as meiosis matches for data identifiers in a fast, efficient format based on integer encoding.

Although FIG. 1 depicts the matched-data-link system 102 located on the server(s) 104, in some implementations, the matched-data-link system 102 may be implemented by (e.g., located entirely or in part on) one or more other components of the environment. For example, the matched-data-link system 102 may be implemented in whole or in part by the client device 108. For example, the client device 108 and/or a third-party system can download all or part of the matched-data-link system 102 (e.g., a match database, one or more relationship clusters, data-link tree structures, and/or ahnentafel structures) for implementation independent of, or together with, the server(s) 104.

In some implementations, though not illustrated in FIG. 1, the environment may have a different arrangement of components and/or may have a different number or set of components altogether. For example, the client device 108 may communicate directly with the matched-data-link system 102, bypassing the network 112. As another example, the environment may include multiple client devices, each associated with a different user account. In addition, the environment can include the database 114 located external to the server(s) 104 (e.g., in communication via the network 112) or located on the server(s) 104 and/or on the client device 108.

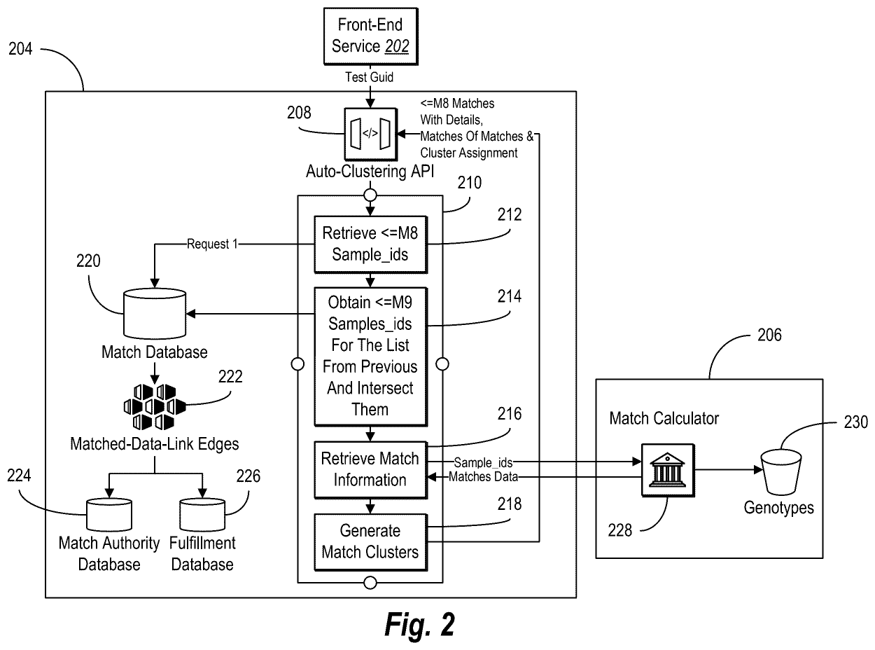

As mentioned above, the matched-data-link system 102 can generate a matched-data-link tree. In particular, the matched-data-link system 102 can generate a matched-data-link tree by using a suite of subroutines, components, processes, and algorithms that contribute to the overall construction of the matched-data-link tree. FIG. 2 illustrates an example overview of a tree generation architecture for the matched-data-link system 102, including various components and processes, in accordance with one or more embodiments. Additional detail regarding the various processes and components introduced in FIG. 2 is provided thereafter with reference to subsequent figures.

As illustrated in FIG. 2, the matched-data-link system 102 includes a front-end service 202. In particular, the front-end service 202 includes or refers to the client application 110 running on the client device 108. In some embodiments, the front-end service 202 can also include additional or alternative components that identify a user account or an individual for whom to generate matches of matches for inclusion in a matched-data-link tree. From the front-end service 202, the matched-data-link system 102 receives user account data linking the user account to a particular genetic evaluation (e.g., a DNA test) and/or genetic data generated and stored within a genomics subsystem 206. The matched-data-link system 102 can also receive a request via user interaction within a matched-data-link tree interface to generate matches of matches for the user account (and/or to generate or update a matched-data-link tree).

As also illustrated in FIG. 2, the matched-data-link system 102 includes a data science subsystem 204. Within the data science subsystem 204, the matched-data-link system 102 includes an auto-clustering application programming interface (API) 208. The matched-data-link system 102 can receive a request from the front-end service 202 to the auto-clustering API 208 for generating relationship clusters associated with a data identifier of a user account. To generate one or more relationship clusters for the data identifiers, the matched-data-link system 102 utilizes additional components and processes as shown in FIG. 2 to generate matches of matches and to implement a relationship clustering algorithm.

To elaborate, as illustrated in FIG. 2, the matched-data-link system 102 generates a relationship cluster (or multiple relationship clusters) using a relationship clustering algorithm 210. As part of the relationship clustering algorithm 210, the matched-data-link system 102 performs an act 212 to retrieve a subset of data matches (e.g., meiosis matches M0 through M8). Indeed, researchers have discovered that approximately 97% of pairs of M8 matches to a proband share DNA. Thus, the matched-data-link system 102 can reduce computational expense and storage requirements by focusing first on M0-M8 matches, omitting M9 matches at this stage (in some cases, M9 matches are much larger than M0-M8 matches and thus require more computing resources to process and store). Accordingly, in one or more embodiments, the matched-data-link system 102 retrieves or accesses the data matches from a match database 220. More particularly, the matched-data-link system 102 accesses the meiosis-level specific data matches for the act 212 from the match database 220.

Moreover, the matched-data-link system 102 determines a particular meiosis match threshold (or cM threshold) to use for determining matches of matches. For example, the matched-data-link system 102 utilizes an M9 threshold (e.g., 20 cM) based on a distribution of shared matches across data identifiers from multiple populations. Indeed, researchers have demonstrated that the M9 threshold captures a threshold proportion of shared matches across hundreds of individuals in multiple populations, rendering the threshold a statistically reliable cutoff between baseline population level sharing (e.g., identity by state (IBS)) and genealogically relevant sharing (e.g., IBD).

Indeed, the matched-data-link system 102 generates and manages the match database 220 using a unique integer encoding approach to storing data match data in a fast, efficient format. To elaborate, the matched-data-link system 102 generates, within the match database 220, a table of rows and columns, where each row represents its own data identifier (as generated by a genetic evaluation or test performed on a sample for an individual). The matched-data-link system 102 further encodes the data identifier as an integer by sequentially numbering each data identifier across the entire genealogical-data system 106. Thus, the matched-data-link system 102 stores each data identifier as an integer in its own row of the match database 220. Within each column of a row, the matched-data-link system 102 further encodes matches (or matched-data-link tree edges 222) of the integer-specific data identifier. Indeed, the matched-data-link system 102 accesses match data from a match authority database 224 and/or from the genomics subsystem 206 to determine matches (e.g., as generated by one or more relationship prediction models) of an integer-specific data identifier.

As a result of encoding each data identifier as an integer, the matched-data-link system 102 can further store each of the identified matches as integers in their own respective columns of the row. The matched-data-link system 102 can automatically update the match database 220 in response to receiving new data identifiers or other genetic data in the match authority database 224 (which stores data match data for data identifiers) and/or the fulfillment database 226 (which stores genetic evaluation data for genetic evaluations/tests). In some embodiments, the matched-data-link system 102 uses the genomics subsystem 206 to update the match database 220 based on detecting newly generated and stored data identifiers (e.g., genotypes 230) generated by a match calculator 228. Additional detail regarding the match database 220 is provided below with reference to subsequent figures.

As further illustrated in FIG. 2, as part of the relationship clustering algorithm 210, the matched-data-link system 102 performs an act 214 to obtain an additional subset of data matches (e.g., M9 matches) for a data identifier. Indeed, the matched-data-link system 102 accesses the match database 220 for quick, efficient retrieval of integer-specific M9 matches of the data identifier. Specifically, the matched-data-link system 102 generates the match database 220 as a table of integer-defined rows and columns while storing and managing the data supporting the table in two separate memory segments, further improving speed and efficiency. Particularly, the matched-data-link system 102 stores the M0-M8 matches in one memory segment and stores the M9 matches in another memory segment, specifically for faster access in the separate retrieval steps of the act 212 and the act 214, respectively.

In some cases, the matched-data-link system 102 further determines (as part of the act 214) intersections of data matches or determines matches of matches. For example, the matched-data-link system 102 determines matches of a data identifier by accessing the row of the integer representing the profile and identifying the integers in the row. In turn, the matched-data-link system 102 determines matches of the matches by accessing the rows specific to each of the respective integers and identifying the integers in each of the rows.

Additionally, as part of the relationship clustering algorithm 210, the matched-data-link system 102 performs an act 216 to retrieve match information. To elaborate, the matched-data-link system 102 interfaces with or includes a genomics subsystem 206 that uses a match calculator 228 to determine matches for data identifiers (or genotypes 230). In some cases, the matched-data-link system 102 generates or determines an identifier of a data identifier to the match calculator 228, whereupon the match calculator 228 determines or generates match data. Particularly, the matched-data-link system 102 determines data identifiers corresponding to the integers defining the matches of matches, provides the data identifiers to the match calculator 228, and uses the match calculator 228 to determine or generate additional match data for generating relationship clusters.

From the match data, as part of the relationship clustering algorithm 210, the matched-data-link system 102 performs an act 218 to generate relationship clusters. More specifically, the matched-data-link system 102 performs additional clustering algorithm steps to process and analyze the match data. Additional detail regarding the relationship clustering algorithm 210 is provided below with reference to subsequent figures.

As noted above, in addition to generating relationship clusters, the matched-data-link system 102 can generate simulation data for validating the relationship clusters (and other genetic evaluations). The matched-data-link system 102 can also use the relationship clusters to generate a matched-data-link tree. Further, the matched-data-link system 102 can perform a traversal of the matched-data-link tree using a traversal algorithm. Additional detail regarding generating simulation data, generating a matched-data-link tree, and traversing the matched-data-link tree is provided below with reference to subsequent figures.

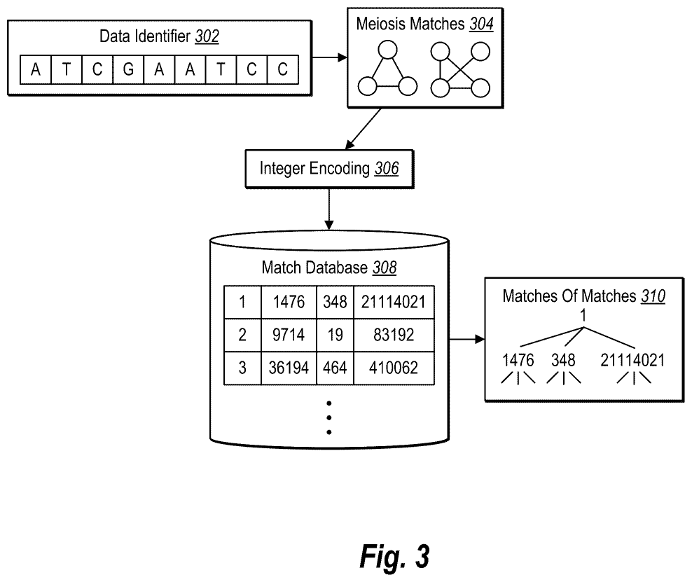

As mentioned above, in certain described embodiments, the matched-data-link system 102 can generate and utilize a match database for determining matches of matches. In particular, the matched-data-link system 102 can determine matches of matches using a match database specifically designed for efficient match encoding and for fast retrieval of matches of matches. FIG. 3 illustrates an example diagram of generating and utilizing a match database to determine matches of matches in accordance with one or more embodiments.

As illustrated in FIG. 3, the matched-data-link system 102 receives or accesses a data identifier 302. In particular, the matched-data-link system 102 receives the data identifier 302 from a client device (e.g., the client device 108) or a front-end service (e.g., the front-end service 202). As shown, the data identifier 302 includes a genotype, a haplotype (e.g., a computer-generated, ordered set of one or more SNPs or other variations), or some other nucleotide sequence defining or representing an individual as determined via a genetic evaluation (e.g., an IBD test).

As also illustrated in FIG. 3, the matched-data-link system 102 determines meiosis matches 304 from the data identifier 302. To elaborate, the matched-data-link system 102 determines the meiosis matches 304 using a match authority database and/or a match calculator. For instance, the matched-data-link system 102 determines the meiosis matches 304 for the data identifier 302 as a set of one or more data identifiers with at least a threshold amount of overlapping (e.g., identical) DNA. Indeed, the matched-data-link system 102 can use an on-demand match calculator system to query for match data calculated on demand, or in some embodiments, can use a large database storage system (e.g., match authority) to retrieve saved data. The matched-data-link system 102 can thus compare the data identifier 302 with other stored data identifiers to determine shared (and different) sequences within respective genotypes at various genomic coordinates (e.g., specific locations within genotypes and/or haplotypes where SNPs occur). In some embodiments, the matched-data-link system 102 uses one or more relationship prediction models to generate or determine the meiosis matches 304 specific to various data match levels (e.g., meiosis levels).

As further illustrated in FIG. 3, the matched-data-link system 102 performs integer encoding 306. More particularly, the matched-data-link system 102 can perform integer encoding 306 to encode the data identifier 302 and the meiosis matches 304 as integers. Indeed, the matched-data-link system 102 can encode each data identifier across the entire genealogical-data system 106 as an integer, sequentially numbering them (or using another numbering paradigm). Thus, matched-data-link system 102 can thus encode millions or billions of data identifiers as integers.

As shown, the matched-data-link system 102 further generates and updates a match database 308 based on the integer encoding 306. Specifically, the matched-data-link system 102 can generate the match database 308 to store a row for each data identifier across the genealogical-data system 106 (e.g., millions or billions of rows). In some cases, the match database 308 includes approximately 26 million rows, one for each data identifier of the genealogical-data system 106. The matched-data-link system 102 defines each row with its own integer representing a respective data identifier. The matched-data-link system 102 further populates the columns of each row with integers representing the meiosis matches 304 and other meiosis matches for each respective data identifier. The matched-data-link system 102 thus generates the match database 308 to include potentially thousands of columns for a profile with thousands of meiosis matches.

As further illustrated in FIG. 3, the matched-data-link system 102 determines or generates matches of matches 310. In particular, the matched-data-link system 102 generates the matches of matches 310 from the match database 308. To determine a match of a match for the data identifier 302, the matched-data-link system 102 accesses the row in the match database 308 of the integer corresponding to the data identifier 302. The matched-data-link system 102 can thus access the meiosis matches 304 in the form of integers along the row, one per column, each representing a data identifier matching the data identifier 302. Further, the matched-data-link system 102 can access each row of the integer matches to determine additional integers in those rows, each row's integers signifying matches of the respective match. Because the match database 308 is small in size (containing only integers), the matched-data-link system 102 can cache the match database 308 in memory for fast access and efficient determine of matches of matches through table queries corresponding to integer matches. As shown, the matched-data-link system 102 determines matches for the data identifier corresponding to the integer “1”—1,476; 348; and 21,114,021—and further determines matches of those three integer matches. In some embodiments, the matched-data-link system 102 can thus (using the match database 308) determine matches of matches of matches (and so on) for a plurality of iterations or linkages from a data identifier.

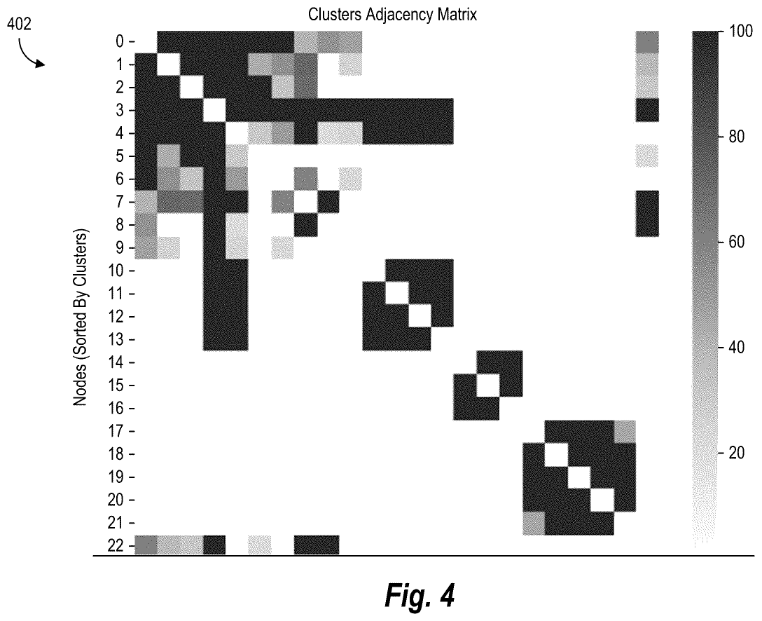

As noted above, in certain described embodiments, the matched-data-link system 102 can generate relationship clusters using matches of matches. In particular, the matched-data-link system 102 can utilize a relationship clustering algorithm to generate relationship clusters for a data identifier based on genetic data associated with matches of matches corresponding to the data identifier. FIG. 4 illustrates an example relationship cluster diagram in accordance with one or more embodiments.

As illustrated in FIG. 4, the matched-data-link system 102 generates a relationship cluster diagram 402 for a data identifier. As shown, the relationship cluster diagram 402 represents matches of the data identifier in a clustered adjacency matrix, where the data identifier is indicated by the diagonal line spanning from top-left to bottom-right. As shown, the matched-data-link system 102 generates the relationship cluster diagram 402 by populating coordinates based on matches of the data identifier. For instance, the matched-data-link system 102 determines meiosis matches of the data identifier and populates an axis (e.g., the x axis and/or the y axis) of the relationship cluster diagram 402 with the integers representing the matches. In some embodiments, the matched-data-link system 102 populates both axes with the same match integers.

As shown, the matched-data-link system 102 further determines meiosis matches between the matches of the data identifier. Indeed, the matched-data-link system 102 queries the match database to determine matches of matches, as described above. In one or more embodiments, the matched-data-link system 102 generates a dark (e.g., black) square at a coordinate where one integer match is a match of another integer match. In some cases, the matched-data-link system 102 generates lighter indicators (e.g., gray squares or lighter patterned squares) where meiosis matches are weaker (e.g., have lower probabilities or confidence scores) than those indicated by darker squares. Accordingly, the matched-data-link system 102 generates white squares for coordinates where no meiosis match exists and/or where the match fails to exceed a probability/confidence threshold. While color-specific distinctions have been described, it will be appreciated that any suitable modality may be used, e.g. numerical distinctions or otherwise.

In one or more embodiments, the matched-data-link system 102 generates relationship clusters at various resolutions (e.g., corresponding to respective data-match levels). Indeed, the matched-data-link system 102 can generate one relationship cluster at a first resolution (e.g., a resolution of a certain number of cM) corresponding to meiosis matches associated with the first resolution. The matched-data-link system 102 can also generate another relationship cluster at a second resolution (e.g., a resolution of a different number cM) corresponding to meiosis matches associated with the second resolution. The matched-data-link system 102 can thus modify the resolution of the relationship cluster diagram 402 to portray or reflect clusters at various data-match levels (e.g., meiosis levels). As shown, the matched-data-link system 102 generates four relationship clusters (denoted by groupings of dark squares of matches) for the data identifier, one (the largest) in the top-left corner, one centrally located, one down and to the right of center, and the last in the bottom-right corner.

To generate a relationship cluster, as mentioned, the matched-data-link system 102 implements a relationship clustering algorithm. For example, the matched-data-link system 102 implements a relationship clustering algorithm that includes multiple steps or processes. In some cases, the relationship clustering algorithm involves determining all M0 through M8 matches for a data identifier and further determining all M0 through M9 matches for each of those matches (e.g., down to 20 cM).

In addition, as part of the relationship clustering algorithm, the matched-data-link system 102 removes or filters out all data matches (e.g., meiosis matches) at data-match level (e.g., meiosis level) M0 for indicating the same person as the proband (e.g., the subject data identifier) and M2 for having the same ancestry as the proband (and thus having the same relationship clusters). The matched-data-link system 102 further removes additional redundant or apparent meiosis matches, including M1 matches because they are either children or redundant on the parental side and M3 matches because they are either children of siblings or are redundant with the parental side.

In some embodiments, as part of the relationship clustering algorithm, the matched-data-link system 102 determines redundant or apparent matches to filter out (e.g., M0-M3 matches) using phasing techniques. Particularly, the matched-data-link system 102 uses a specialized phasing technique to determine which alleles (e.g., SNPs or other variants) are inherited together on the same chromosome from each parent to thus identify which parts of DNA, e.g. haplotypes, come from the maternal side and which from the paternal side. Through phasing, the matched-data-link system 102 combines multiple data points, including results from genetic evaluations (e.g., IBD tests) from related data identifiers or matches of a data identifier (e.g., a proband) to refine the phasing process. Through phasing across genetic information from multiple family members or matches, the matched-data-link system 102 can more accurately phase a proband genotyping results into haplotypes, reducing errors compared to standard approaches to phasing on the proband genotyping results in isolation.

In some embodiments, the matched-data-link system 102 phases a proband using haplotype clustering models and/or graph-based methods to generate sub-clusters of data identifiers with shared genetic segments, as described by Thi Hong Luong Nguyen et al. in U.S. patent application Ser. No. 16/936,444, titled CLUSTERING OF MATCHED SEGMENTS TO DETERMINE LINKAGE OF DATASET IN A DATABASE, filed Jul. 23, 2020, and/or by Keith D. Noto in U.S. patent application Ser. No. 18/377,487, titled DETERMINING DATA INHERITANCE OF DATA SEGMENTS, filed Oct. 6, 2023, now issued as U.S. Pat. No. 12,050,629, both of which are hereby incorporated by reference in their entireties.

Continuing with the relationship clustering algorithm, the matched-data-link system 102 further removes or filters out the proband (e.g., the genotype of the data identifier). The matched-data-link system 102 further constructs or generates an n×n sparse graph with all remaining (unfiltered) meiosis matches. In some cases, the matched-data-link system 102 generates two sparse graphs (e.g., by dividing the n×n graph), one for P1 (e.g., parent one) and the other for P2 (e.g., parent two). This it can do by virtue of the phased results, as discussed above, allowing matches on a particular parental haplotype to be compared exclusively.

As part the clustering algorithm, the matched-data-link system 120 filters out two pieces of information: 1) cluster labels (or cluster assignments) and/or 2) matches or edges between data identifiers or individuals. As part of this process, the matched-data-link system 102 performs an ensemble of clustering processes to cluster matches in each of the graphs, including Louvain Community Detection, Spectral Clustering, and Agglomerative Hierarchical Clustering. Because each clustering process has its own strengths and weaknesses which differ from one another, the matched-data-link system 102 can combine the results in an ensemble approach to bolster relationship clustering. Indeed, the matched-data-link system 102 can use one clustering process to compensate for another in areas where it is weak, and vice-versa.

As further processes in the relationship clustering algorithm, the matched-data-link system 102 can filter additional cluster label/assignments and/or edges/matches. Particularly, the matched-data-link system 102 can filter or omit cluster assignments for data identifiers with less than a threshold (e.g., 30%) connectivity to an assigned cluster at a threshold of 20 cM (or some other relationship distance). The matched-data-link system 102 can further re-apply the ensemble of clustering approaches (Louvain Community Detection, Spectral Clustering, and Agglomerative Hierarchical Clustering) to the remaining data identifiers to determine edges or matches between them. In addition, or alternatively, the matched-data-link system 102 can retain edges between two data identifiers that have the same cluster in at least two of the three clustering processes (and neither assignment of the data identifiers is unassigned). Otherwise, the matched-data-link system 102 removes the edge or the match between the data identifiers.

The matched-data-link system 102 can repeat the filtering process of applying a threshold connectivity at a threshold relationship distance using different thresholds, each time re-applying the ensemble of clustering processes or a different process or ensemble of processes to the result. For instance, the matched-data-link system 102 utilizes a connectivity threshold of 50% with a relationship distance threshold of 20 cM for a second clustering iteration, keeping edges for data identifiers clustered in at least two of the three clustering processes. Likewise, the matched-data-link system 102 can perform a third iteration with a connectivity threshold of 50% and a relationship distance threshold of 40 cM, and the matched-data-link system 102 can re-apply the ensemble of clustering processes to keep edges for data identifiers matched in at least two of them. The matched-data-link system 102 can perform a fourth clustering iteration with a connectivity threshold of 60% and a relationship distance threshold of 20 cM. In some embodiments, after the fourth iteration, the matched-data-link system 102 can perform agglomerative clustering to determine the final cluster labels.

In One or More Embodiments, the Matched-Data-Link System 102 Utilizes a Relationship Clustering Algorithm Made Up of Computer Code Defining Subroutines or Processes for the Following Functions:
Identify matches of a proband along an unphased genotype and/or a phased haplotype
Remove all data identifiers who match proband at:
   m0: These are the same person
   m2: These matches have the same ancestry
   m1: These matches are either children, or are redundant with the parental side
   m3: These matches are either children of siblings, or are redundant with the parental side
Remove the proband
Construct an n×n sparse graph with all remaining matches. Divide into 2 for all matches with a P1 label and a P2 label.
Cluster the graph using Louvain Community Detection, Spectral Clustering, and Agglomerative Hierarchical Clustering.
Filter network:
   For all individuals who have 30% connectivity to the assigned cluster at a threshold of >20 cM, remove the cluster assignment
   For all individuals who are in the same cluster in 2 out of the 3 clustering methods, keep the edge between them. Otherwise, remove the edge unless the individuals do not belong to any clusters.
Run clustering with same three methods
Filter network, this time with a threshold of 0.50 and a threshold of 20 cM.
Run clustering with the same three methods.
Filter network with a threshold of 0.50 and a threshold of 40 cM.
Run clustering with the same three methods.
Filter network with a connectivity of 0.60 and a threshold of 20 cM
Run agglomerative clustering to get the final cluster labels

The matched-data-link system 102 can thus generate relationship clusters using a clustering algorithm. The following example is illustrative of the auto-clustering process of applying Louvain Community Detection, Spectral Clustering, and Agglomerative Hierarchical Clustering at multiple steps, each with their own respective thresholds.
STEP 1 (for each cluster for each method)
   Cluster 1 for Spectral Clustering:
   A, B, C, D
   A matches B (connectivity=⅓=0.33)
   B matches A, C, and D (connectivity=3/3=1.0)
   C matches B and D (connectivity=⅔=0.66)
   D matches C and D (connectivity=⅔=0.66)
   Threshold=0.5
   Filtered Cluster 1:
   B, C, D
   A is now unassigned.
STEP 2 (for each match in the network)
   Cluster assignments:
   Id: spectral cluster, agglomerative cluster, Louvain cluster
   A: unassigned (now), unassigned, unassigned
   B: 1, 2, 2
   C: 1, 2, 3
   D: 1, 2, 3
   E: 3, 9, 3
   F: 3, 4, 3

The matched-data-link system 102 examines the edge between A and B. The matched-data-link system 102 never assigns A to a cluster, so the matched-data-link system 102 removes the edge. The matched-data-link system 102 examines the edge between B and C. Because B and C match clusters in ⅔ of the methods, the matched-data-link system 102 retains the edge. The matched-data-link system 102 examines the edge between B and E. Because B and E are never in the same cluster, the matched-data-link system 102 removes the edge.

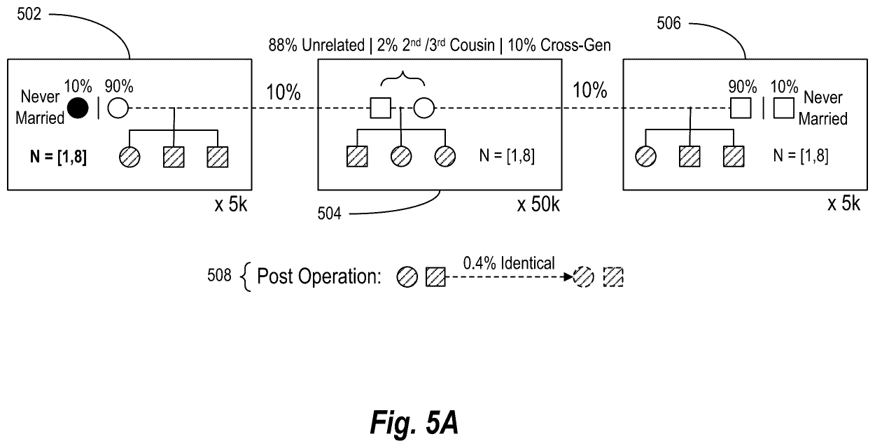

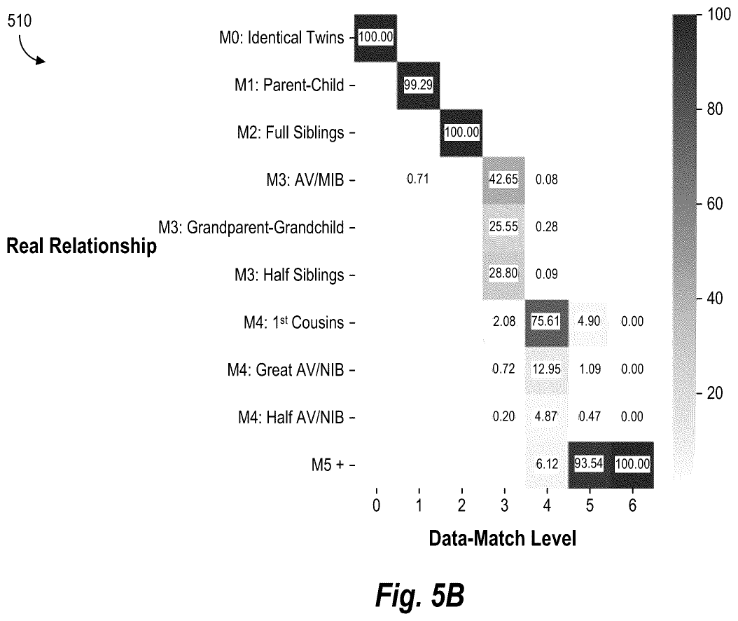

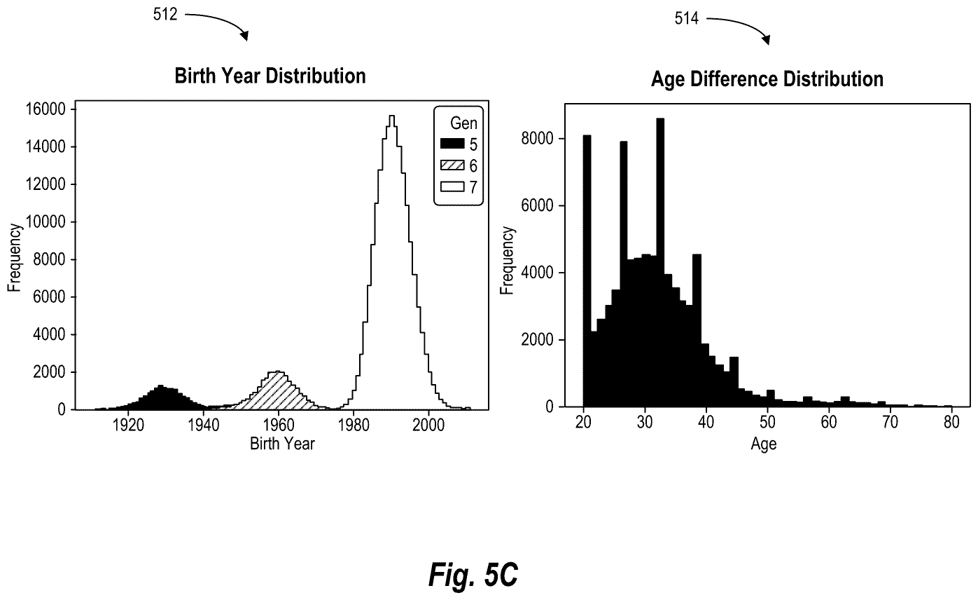

As mentioned above, in certain described embodiments, the matched-data-link system 102 generates a simulation dataset for validating relationship clusters and/or other genetic evaluations. In particular, the matched-data-link system 102 generates a simulation dataset using unique simulation parameters and data generation algorithms. FIGS. 5A-5C illustrate example diagrams for generating a simulation dataset in accordance with one or more embodiments.

As motivation for generating a simulated dataset, the matched-data-link system 102 uses simulated data to verify or validate the efficacy of determining matches of matches, clustering, and performing other genetic evaluations. Indeed, the matched-data-link system 102 generates to: 1) have a large, realistic dataset where the truth of tree and DNA relationships is known and 2) have a dataset that has non-identifiable genetic information, while maintaining realistic genomic structure. Without such a simulated dataset, the matched-data-link system 102 must rely on potentially messy user-annotated data-link trees, which are unreliable for measuring the accuracy of clustering algorithms (and match of match determinations) in that they include missing and incorrect information. As part of generating a simulated dataset, the matched-data-link system 102 further employs pre-production validation measures to implement, adjust, and validate system algorithms in a non-production environment (e.g., in an L2 non-production environment). Prior systems have relied on an L1 live production environment for all genetic evaluations and applications because they had no access to reliable test data for development environments (e.g., in L2 or L3 environments for testing and validation). Building and testing individual components of an algorithm piece by piece at the production environment level is challenging and computationally expensive. Thus, by generating, testing, and preparing a simulated dataset as described herein, the matched-data-link system 102 facilitates building software pieces in non-production environments (e.g., L2), removing the expense and time-sensitive nature of working in a live production environment.

As illustrated in FIG. 5A, the matched-data-link system 102 generates a simulated dataset by generated simulated data identifiers over a number of generations. For instance, the matched-data-link system 102 augments existing, stored data identifiers using simulated admixture over a number of generations ranging from 5 to 8 (or 10 or some other number of) generations. For example, the matched-data-link system 102 anonymizes and augments the genotypes (or haplotypes) of data identifiers to generate a set of simulated data identifiers that resemble genetic probabilities and occurrences in real-world populations.

To generate a simulated dataset, the matched-data-link system 102 utilizes a set of tunable simulation parameters, including a cousin marriage rate, a cross-generation relationship rate, and a half-sibling rate (or a reformed family rate). For instance, the matched-data-link system 102 sets the cousin marriage rate to 2%, the cross-generation relationship rate to 10%, and the half-sibling rate to 20%, reflective of real-world populations. In some cases, the matched-data-link system 102 sets (as a tunable simulation parameter) an unrelated marriage rate as well (e.g., 88%). The matched-data-link system 102 can further set (as a tunable simulation parameter) an identical twin rate based on a statistical occurrence of identical twins (e.g., 0.4%).

To generate a simulated dataset, the matched-data-link system 102 generates simulated data identifiers 502. More particularly, the matched-data-link system 102 generates simulated data identifiers for females represented by circle shapes, where 10% never married, 90% married (10% of which married someone from another generation) and had a randomly selected number of children in a range of 1 to 8, where the gender is also randomly selected with a 50/50 chance between male and female. As shown, the matched-data-link system 102 generates five thousand (or some other proportionate amount) such simulated data identifiers for females. The matched-data-link system 102 can generate five thousand sets of the simulated data identifiers 502, where each set includes the children as well.

Additionally, as shown, the matched-data-link system 102 generates simulated data identifiers 506. In particular, the matched-data-link system 102 generates simulated data identifiers for males represented by square shapes, where 10% never married, 90% married (10% of which married someone from another generation) and had a randomly selected number in a range of 1 to 8 children, where the gender is also randomly selected with a 50/50 chance between male and female. As shown, the matched-data-link system 102 generates five thousand (or some other proportionate amount) such simulated data identifiers for males. The matched-data-link system 102 can generate five thousand sets of the simulated data identifiers 504, where each set includes the children as well.

As further illustrated in FIG. 5A, the matched-data-link system 102 generates simulated data identifiers 504. In particular, the matched-data-link system 102 generates a set of simulated data identifiers that includes a male and female who have a random number of children in a range of 1 to 8, where the gender is also randomly selected with a 50/50 chance. As shown, the matched-data-link system 102 generates fifty thousand (or some other proportionate amount) such simulated data identifiers. The matched-data-link system 102 can generate fifty thousand sets of the simulated data identifiers 504, where each set includes the children as well.

Through each generation, the matched-data-link system 102 randomly sorts the children from the previous generation that can be paired up for having more children (also including those of the previous generation based on the 10% cross-generation relationship parameter), thus producing the next generation and so on (through the number of generations). As shown, the matched-data-link system 102 also sets a parameter 508 for the statistical occurrence of identical twins (0.4%) in real-world populations. In such cases, the matched-data-link system 102 copies the genotype of one simulated data identifier to generate another identical simulated data identifier. Using these parameters, the matched-data-link system 102 thus generates a set of simulated data identifiers across multiple generations.

Researchers have demonstrated that the parameters, values, and the matched-data-link system 102 accurately generate a simulated dataset using the tunable simulation parameters. As shown by the table below, researchers tested the generation of the simulation dataset, showing that the cousin marriage rate was effectively 2%, the cross-generation relationship rate (or cross-generation marriage rate) was effectively 10%, and the half-sibling rate (or reformed family rate) was effectively 20%.

| Generation | Cousin(%) | Cross-Gen(%) | Reformed(%) |
|---|---|---|---|
| 1 | 0 | 0 | 20.12 |
| 2 | 0 | 9.82 | 20.12 |
| 3 | 0 | 10.15 | 19.91 |
| 4 | 1.98 | 10.06 | 20.08 |
| 5 | 2.02 | 10.22 | 19.81 |
| 6 | 2.04 | 10.02 | 19.75 |

As illustrated in FIG. 5B, researchers have also demonstrated that the data-match levels (e.g., meiosis levels) of the simulated data accurately reflect real (e.g., familial) relationships of data identifiers. For example, as shown in graph 510, the matched-data-link system 102 generates simulated data identifiers at M0 matches that are identical twins 100% of the time. Similarly, the matched-data-link system 102 generates simulated data identifiers for parents and children that accurately reflect M1 matches, and likewise throughout the graph 510 for all meiosis matches.

As illustrated in FIG. 5C, the matched-data-link system 102 generates simulated metadata for simulated data identifiers. Indeed, the matched-data-link system 102 generates simulated birth years across the generations of simulated data identifiers. For instance, the matched-data-link system 102 determines a statistical distribution of birth years in a population and determines the simulated birth years based on the distribution. In some cases, the matched-data-link system 102 uses the formula N (Mean, 5) to generate normal distribution with a given mean and a variance of 5. As shown in the graph 512, the matched-data-link system 102 determines a birth year distribution for different generations of simulated data identifiers, where the mean for generation five is 1930, the mean for generation six is 1960, and the mean for generation seven is 1990.

As shown in the graph 514, the matched-data-link system 102 also accounts for a distribution of age difference in determining simulated birth years. Indeed, the matched-data-link system 102 determines an age difference in populations and sets the distribution between a minimum of twenty years and a maximum of eighty years. The matched-data-link system 102 also generates simulated birth years that are identical for a statistical occurrence of identical twins (e.g., 0.4%). Based on the birth year distribution and the age difference distribution, the matched-data-link system 102 determines simulated birth years for simulated data identifiers.

In addition, the matched-data-link system 102 generates simulated surnames for simulated data identifiers. In some cases, the matched-data-link system 102 generates simulated surnames by randomly selecting a capital letter at the beginning of a surname and generating a length having a normal distribution with a tunable mean and standard deviation—e.g., N (6, 1)—ranging between 3 and 9 characters. Across 221,484 data identifiers, the matched-data-link system 102 generates 14,145 unique surnames.

Researchers have demonstrated the efficacy of the simulation dataset. Indeed, as shown in the table below, researchers tested the number of meiosis matches per data identifier (averaged across a number of data identifiers). Aiming to achieve approximately 130 matches combined for M7 and M8 matches, as reflected in real-world populations, researchers demonstrated that the simulated dataset of the matched-data-link system 102 accurately produces 92.67 M7 matches+41.73 M8 matches for a total of 134.4 combined M7-M8 matches.

| Meiosis Level | 0 | 1 | 2 | 3 | 4 | 5 | 6 | 7 | 8 | 9 | 10 |
|---|---|---|---|---|---|---|---|---|---|---|---|
| Average | 0.0072 | 0.76 | 2.01 | 3.02 | 10.10 | 12.72 | 27.48 | 92.67 | 41.73 | 628.34 | 1178.04 |

As mentioned above, in certain described embodiments, the matched-data-link system 102 determines candidate tree configurations or data-link tree structures for relationship clusters. In particular, the matched-data-link system 102 can determine data-link tree structures for data identifiers and can further determine probabilities of structure locations where nodes corresponding to data identifiers should be placed. FIG. 6A illustrates an example diagram for determining data-link tree structures in accordance with one or more embodiments.

As illustrated in FIG. 6A, the matched-data-link system 102 accesses or determines relationship clusters 602. In particular, the matched-data-link system 102 determines relationship clusters 602 as described above. From the relationship clusters 602, the matched-data-link system 102 further determines a first data-link tree structure 604 for a first data identifier, a second data-link tree structure 606 for a second data identifier, and a third data-link tree structure 608 for a third data identifier.

For instance, the matched-data-link system 102 generates a set of related individuals from a relationship cluster created using a relationship clustering algorithm. In addition, the matched-data-link system 102 determines a data-link tree structure for arranging the set of related individuals based on relationships among the set of related individuals. Indeed, from a set of related individuals for a data identifier, the matched-data-link system 102 can determine factors or metrics corresponding to the relatedness of the individuals, including meiosis levels, genomic data for specific data variants (e.g., SNPs) or haplotypes, and familial relationship data indicating familial relationships (e.g., father, mother, uncle, grandmother). Using these data, the matched-data-link system 102 can determine probabilities or likelihoods for various data-link tree structures corresponding to, fitting, or representing a relationship cluster. In some cases, the matched-data-link system 102 can select a data-link tree structure for an individual (e.g., a data identifier) or for a relationship cluster as a structure with a highest (or at least a threshold) structure probability to represent or organize a relationship cluster corresponding to the individual. In one or more embodiments, the matched-data-link system 102 utilizes matches of matches from a first data identifier and constructs a data-link tree structure from the matches of matches (e.g., without using the relationship clustering algorithm to generate a relationship cluster).

The matched-data-link system 102 further populates the data-link tree structure with identifiers corresponding to the set of related individuals by permuting the data-link tree structure to determine, for respective individuals of the set of related individuals, location probabilities of belonging in structure locations within the data-link tree structure. Indeed, based on the relationship data from the relationship cluster and/or other meiosis match data, the matched-data-link system 102 can determine probabilities corresponding to various nodes or structure locations for placing the data identifier of the proband as well as data identifiers of other individuals (e.g., matches) corresponding to the proband.

As mentioned above, the matched-data-link system 102 can combine data-link tree structures into a matched-data-link tree. In particular, the matched-data-link system 102 can combine data-link tree structures based on probabilities of structure locations for various data identifiers by combining and comparing probabilities across various data-link tree structures. FIG. 6B illustrates an overview of generating and merging one or more data-link trees into a final tree.

As illustrated in FIG. 6B, the matched-data-link system 102 utilizes input 611, comprising metadata, auto-clustering and matches data, M0-M4 relationship prediction, and parental side prediction. In particular, the input 611 includes or refers to information from the genealogical-data system 106 running on the server(s) 104 or the client application 110. In some embodiments, the input 611 includes metadata, such as birth year for a data identifier. In addition, input 611 can include auto-clustering and matches data, including matches of matches data. In one or more embodiments, the input 611 includes M0-M4 (or other M-level) relationship prediction data. For example, the M0-M4 relationship prediction data includes information about data identifiers closely related to the proband (e.g., from the proband tree relationship discussed in more detail in FIG. 6F) based on data-match level. In some embodiments, the input 611 includes a parental side prediction for a data identifier relative to the proband.

As also illustrated in FIG. 6B, the matched-data-link system 102 includes an act 612 to categorize the input 611. In particular, the matched-data-link system 102 separates the input 611 into the proband and M0-M4 matches (e.g., closely related matches based on data-match level). In addition, the matched-data-link system 102 separates the input 611 into M4-M8 matches (e.g., data identifiers with more distance data-match levels) from each relationship cluster. In some embodiments, data identifiers from one cluster are also present in another cluster. For example, a data identifier in a first cluster may have a different data link with the proband or other data identifiers in a second cluster. Additionally, in one or more embodiments, the matched-data-link system 102 may use matches of matches data for a data identifier as the input 611. For example, the matched-data-link system 102 may use matches of matches without using the relationship clustering algorithm.

As further illustrated in FIG. 6B, the matched-data-link system 102 includes an act 613 to generate a data-link tree. In particular, the act 613 includes generating and populating a data-link tree. The act 613 is described in detail in FIG. 6C, with various details described in greater detail in FIGS. 6D-6J. In particular, the matched-data-link system 102 can generate and populate a data-link tree for each relationship cluster. In some embodiments, the matched-data-link system 102 can generate more than one data-link tree from a single relationship cluster.

As illustrated in FIG. 6B, the matched-data-link system 102 includes an act 614 output the data-link tree and any other data. For example, the matched-data-link system 102 may generate a data-link tree from a relationship cluster and still have data identifiers (e.g., from the input 611) that the matched-data-link system 102 did not place into the data-link tree. In one or more embodiments, the data identifiers not placed into the data-link tree are different for each data-link tree. In some embodiments, the data identifiers that the matched-data-link system 102 does not place into a data-link tree have more distant data-match levels (e.g., data-match levels above a threshold such as M5).

As also illustrated in FIG. 6B, the matched-data-link system 102 includes an act 615 to expand a data-link tree generated by the act 613 based on the output from the act 614. In particular, the act 615 utilizes the data-link tree generated by the step 613 and the data identifiers not placed by the matched-data-link system 102 (e.g., as organized during the step 614) to expand the data-link tree. In some embodiments, the matched-data-link system 102 places one or more data identifiers not already placed into the data-link tree during the act 615. In addition, once the matched-data-link system 102 has expanded the data-link tree by the act 615, the matched-data-link system 102 outputs the expanded data-link tree as a cluster tree.

As further illustrated in FIG. 6B, the matched-data-link system 102 includes an act 616 to merge one or more data-link trees. In particular, once all data-link trees have been merged by the act 616, the matched-data-link system 102 generates a final tree 618. In some embodiments, the matched-data-link system 102 utilizes one or more cluster trees generated by the act 615 to merge with the proband close relationship tree generated by the act 613. In one or more embodiments, once the matched-data-link system 102 merges a cluster tree with the proband close relationship tree, the matched-data-link system 102 outputs the result as a merged tree. In addition, for each iteration that the matched-data-link system 102 merges a cluster tree into a merged tree, the matched-data-link system 102 generates a new merged tree (e.g., merged tree 1 becomes merged tree 2). Once the matched-data-link system 102 finalizes merging cluster trees into merged trees, the matched-data-link system 102 outputs the result as the final tree 618.

As mentioned above, in certain described embodiments, the matched-data-link system 102 can generate and merge one or more data-link trees. In particular, the matched-data-link system 102 can take data about a proband and one or more associated relationship clusters, generate one or more data-link trees from the one or more associated relationship clusters, expand the one or more data-link trees, and merge the one or more data-link trees to create a final tree. In addition, the matched-data-link system 102 can generate a data-link tree based on data-match levels of matches in the relationship cluster. FIG. 6C illustrates an example overview of a tree initialization or generation algorithm for generating and populating a data-link tree from a relationship cluster in accordance with one or more embodiments. Additional detail regarding the various processes and components introduced in FIG. 6C is provided thereafter with reference to subsequent figures.

As illustrated in FIG. 6C, the matched-data-link system 102 includes an act 620 to generate a data-link tree. The act 620 includes an act 621 to select a relationship cluster 622. In particular, the act 621 includes or refers to the genealogical-data system 106 running on the server(s) 104 or in the client application 110. In some embodiments, the act 621 can also include additional or alternative components that select the relationship cluster 622 from a set of relationship clusters that the matched-data-link system 102 identified. The relationship cluster 622 may also include a data identifier (e.g., proband) and a plurality of nodes. The plurality of nodes may comprise a set of nodes to place, including related data identifiers for N nodes within the relationship cluster (e.g., related data identifier 1 through related data identifier N). In some embodiments, the matched-data-link system 102 can perform the act 621 through a trained machine learning model.

As also illustrated in FIG. 6C, the matched-data-link system 102 performs an act 623 to select a next node from the relationship cluster 622. The matched-data-link system 102 can access an edge selector for the act 623 to select a placed node and a next node. Additional detail regarding the edge selector is detailed below in FIGS. 6D-6E. The matched-data-link system 102 can perform the act 623 with respect to the relationship cluster 622 and can select the next node from a related data identifier in the set of nodes to place. In one or more embodiments, the matched-data-link system 102 utilizes a machine learning model as the edge selector. The matched-data-link system 102 can use the edge selector to detail a plurality of relationships between various nodes—including placed nodes and nodes to place—to perform the act 623.

As further illustrated in FIG. 6C, the matched-data-link system 102 can perform an act 624 to predict a relationship between the placed node and the next node (e.g., a predicted data link). The act 624 can include a relationship predictor, as detailed further in FIGS. 6D-6E, to determine a relationship between the placed node and the next node. The matched-data-link system 102 can determine a relationship between a placed node and a node to add based on information about the relationship between the two nodes. In one or more embodiments, the matched-data-link system 102 predicts a relationship between two nodes based on data-match level, shared cM, number of shared segments, and metadata for the nodes (e.g., birth year). In addition, the matched-data-link system 102 can access a machine learning model trained to predict a relationship based on data-match level, shared cM, number of shared segments, node metadata, or other criteria in order to predict a relationship between nodes. In some embodiments, the matched-data-link system 102 can predict more than one potential relationship between the placed node and the next node (e.g., father and grandfather, first cousin and second cousin).

As additionally illustrated in FIG. 6C, the matched-data-link system 102 can perform an act 625 to add a next node to one or more data-link trees. The act 625 can include a function to set a relationship between a placed node and the next node. In addition, the set relationship function can establish a relationship between two placed nodes. Indeed, in some embodiments, the matched-data-link system 102 can set a relationship between two placed nodes. For example, the matched-data-link system 102 can utilize a machine learning model to determine and generate the set relationship. In one or more embodiments and as part of the act 625, the matched-data-link system 102 generates one or more candidate data-link trees based on the predicted relationship between the placed node and the next node. For example, if the matched-data-link system 102 determines that the placed node is a grandchild of the next node, the act 625 can generate four candidate data-link trees for each potential placement of the next node as a grandparent: maternal grandmother, maternal grandfather, paternal grandmother, and paternal grandfather. In some embodiments, the matched-data-link system 102 generates fewer candidate data-link trees based on other information, e.g., the biological sex associated with the data identifier of the next node. The process to generate candidate data-link trees is described below in greater detail in FIG. 6G.

As illustrated in FIG. 6C, the matched-data-link system 102 can perform act 626 to evaluate one or more candidate data-link trees from the act 625. The act 626 can include a calculate likelihood function. The act 626 can further include outputting a placement likelihood value for a candidate data-link tree. In one or more embodiments, the calculate likelihood function includes an objective calculation and a distribution paradigm. Specifically, the matched-data-link system 102 can select a distribution paradigm by selecting a methodology to calculate a distribution (e.g., a binned distribution, a fitted distribution, a tree seedling distribution). In some embodiments, the matched-data-link system 102 calculates the objective based on the distribution from the distribution methodology. For example, the objective calculation may be a negative log likelihood of the candidate data-link tree based on the distribution. Based on the calculate likelihood function, the matched-data-link system 102 can generate a placement likelihood value for a candidate data-link tree. In one or more embodiments, the matched-data-link system 102 utilizes a trained machine learning model to calculate a placement likelihood value utilizing one or more distribution methodologies. Additionally, the matched-data-link system 102 can use a likelihood calculation (e.g., placement likelihood value from the calculate likelihood function, objective calculation) to determine a data-match value.

As also illustrated in FIG. 6C, the matched-data-link system 102 can perform an act 628 to filter the candidate data-link trees and select the most likely candidate data-link tree to be a primary data-link tree. The act 628 can include a filter function that determines the primary data-link tree based on placement likelihood values of the candidate data-link trees. For example, the matched-data-link system 102 may implement a machine learning model to perform all or part of the filter function. In some embodiments, the matched-data-link system 102 can select more than one primary data-link tree from the candidate data-link trees. Specifically, once the matched-data-link system 102 filters and selects one or more primary data-link trees, the matched-data-link system 102 uses the one or more primary data-link trees to repeat the act 623 with the one or more primary data-link trees for the next node to be placed. In one or more embodiments, the acts iterate, and as one primary data-link tree results in lower placement likelihood values in the act 626, the matched-data-link system 102 filters out the less likely primary data-link tree. Indeed, an incorrect node placement may initially result in high placement likelihood values, but the error may compound over iterations, resulting in decreased placement likelihood values. In some embodiments, the matched-data-link system 102 keeps a candidate data-link tree despite a lower calculated placement likelihood value. The act 628 is described in greater detail below in FIG. 6I.

In addition, the act 628 may include additional processes as part of the filter function. For instance, in some embodiments, the filter function can include a perturbation step. In some embodiments, the matched-data-link system 102 perturbs one or more candidate data-link trees or one or more primary data-link trees using a perturbation algorithm, as detailed below with regard to FIG. 6H. Further, the matched-data-link system 102 may perturb the data-link trees at random by changing or removing one or more edges. Alternatively, the matched-data-link system 102 may perturb the data-link trees at random by changing or removing one or more nodes. In one or more embodiments, the matched-data-link system 102 perturbs the data-link trees by changing or removing edges and nodes.

In some embodiments, the matched-data-link system 102 perturbs one or more candidate data-link trees according to a perturbation method. As discussed in FIG. 6H below, the matched-data-link system 102 performs a specific perturbation method based on a specific node. Similarly, the matched-data-link system 102 may perform a perturbation and remove one or more placed nodes. In one or more embodiments, the matched-data-link system 102 can perturb one or more primary data-link trees and return any removed nodes into the group of nodes to place by the act 621.

As mentioned above, in certain described embodiments, the matched-data-link system 102 can generate and filter candidate data-link trees. In particular, the matched-data-link system 102 can select a relationship cluster, place a node into the cluster, and generate candidate data-link trees based on a predicted relationship (e.g., a predicted data link). In addition, the matched-data-link system 102 can evaluate and filter the candidate data-link trees based on placement likelihood value to generate primary data-link trees. Further, then matched-data-link system 102 can iterate the process for all nodes in the relationship cluster and the system generates final primary data-link trees. FIG. 6D-6E illustrate example diagrams of selecting a next node, predicting a relationship, and adding the next node to the existing data-link tree in accordance with one or more embodiments.

As shown in FIG. 6D, the matched-data-link system 102 generates a candidate data-link tree 638 from a data-link tree 630 and a node chart 634 detailing the relationship between nodes to add and a placed node. Specifically, the figure shows the edge selector 632 generating the node chart 634 based on the relationship of three nodes to the placed node in the data-link tree 630. In some embodiments, the node chart 634 includes a line for each node in the relationship cluster not yet added to the data-link tree. In other embodiments, the node chart 634 can include multiple lines for the same node to add based on relationships to more than one placed node in the data-link tree 630. As depicted in FIG. 6D, the matched-data-link system 102 inputs the node chart 634 (comprising a list of placed nodes and associated next nodes to be placed) into the relationship predictor 636 to determine which node will be added to the data-link tree 630. As seen in the candidate data-link tree 638, the matched-data-link system 102 selected the square with an M1 data-match level relationship to the placed node. Using the relationship predictor 636, the matched-data-link system 102 placed the node onto the data-link tree 630 as a parent (specifically, the father) of the placed node. In one or more embodiments, the matched-data-link system 102 can generate an additional candidate data-link tree 638 in which the placed node is the mother.

In FIG. 6E, the matched-data-link system 102 uses the output of FIG. 6D as the starting point for placement of an additional node. Here, the output in FIG. 6D is depicted as a data-link tree 640, and the matched-data-link system 102 used the edge selector 642 to generate a node chart 644. As seen in the node chart 644, the list of nodes and relationships includes nodes to add based on a relationship to either of the placed nodes in the data-link tree 640. The matched-data-link system 102 provides the node chart 644 to the relationship predictor 646, and the matched-data-link system 102 selects the circle with the M1 match to the previously placed square. Consequently, the candidate data-link tree 648 includes the most recent node added as the parent and grandparent of the placed nodes. In one or more embodiments, the placement of a node based on one relationship can negatively impact the placement likelihood value of the candidate data-link tree 648 as a whole based on other placed nodes.

As mentioned above, in certain described embodiments, the matched-data-link system 102 can determine a set of potential next nodes, predict the relationship of nodes to add to one or more placed nodes, and add a node to the data-link tree to generate a candidate data-link tree. In particular, the matched-data-link system 102 can generate more than one candidate data-link trees based on the relationship of the placed node. FIG. 6F illustrates example diagrams depicting the accuracy of predicting a relationship based on different methods in accordance with one or more embodiments.

As illustrated in FIG. 6F, the matched-data-link system 102 can predict a relationship between nodes using different methods with different accuracies. The figure depicts a proband tree graph 650 and a cluster tree graph 652, with each graph showing prediction accuracy for the method at different data-match levels (e.g., meiosis levels). In one or more embodiments, factors that affect prediction accuracy include edge selector methodology (e.g., proband based, closest, shortest edge), relationship prediction methodology (e.g., ideal, default, naïve), distribution (e.g., binned, fitted, tree seedling), and likelihood loss methodology (e.g., binned, tree seedling, simulation fitted). In particular, as data-match levels between nodes increase, prediction accuracy decrease. To improve prediction accuracy, the matched-data-link system 102 implements different conditions for relationship prediction based on confidence and data-match levels. As depicted in FIG. 6F, relationship prediction accuracy for the proband tree graph 650 is better for data-match levels 1-4. Compared to the cluster tree graph 652, the predictions are more accurate, have less variation, or both. However, at data-match level 5, FIG. 6F depicts the accuracy of proband tree graph 650 as comparable but with more variation than the cluster tree graph 652. At data-match level 6, prediction accuracy of the matched-data-link system 102 using the proband tree method decreases drastically, as depicted in FIG. 6F and the proband tree graph 650. In some embodiments, the matched-data-link system 102 uses the proband tree relationship methodology to predict relationships for data-match levels 0-4 and the cluster tree relationship methodology to predict relationships for data-match levels greater than 4. Therefore, the matched-data-link system 102 improves prediction accuracy by conditioning predictions based on confidence and data-match levels.

As mentioned above, in certain described embodiments, the matched-data-link system 102 predicts relationships using different methodologies based on data-match levels between nodes. In particular, the matched-data-link system 102 uses one relationship prediction methodology (e.g., proband tree relationship) for data-match levels within the 0-4 threshold and a different relationship prediction methodology (e.g., cluster tree relationship) for data-match levels above the 0-4 threshold. FIG. 6G illustrates an example diagram generating candidate data-link trees by determining a relationship between a node and a placed node in accordance with one or more embodiments.

As illustrated in FIG. 6G, the matched-data-link system 102 can perform an act 666 to generate candidate data-link trees 668 from an existing data-link tree 660 based on a set relationship 664 between a node and a placed node. In one or more embodiments, an existing data-link tree 660 can include one or more placed nodes 662 placed nodes 662. As depicted in FIG. 6G, the existing data-link tree 660 includes node A and node B as placed nodes 662. In some embodiments, the matched-data-link system 102 may utilize more than one existing data-link tree 660 for the act 666 (e.g., if the matched-data-link system 102 generated more than one primary data-link tree during the previous iteration). Further, in the same or other embodiments, the matched-data-link system 102 may include multiple relationships within the set relationship 664 (e.g., first cousin and second cousin).

In particular, the set relationship 664 may include more relationships as the data-match level between the node and the placed node increases. As depicted in FIG. 6G, the matched-data-link system 102 determined the set relationship 664 between node B and node C as grandson, meaning that B (the placed node) is the grandson of node C (node to add). Here, node B has an associated biological sex (e.g., from metadata associated with the node), but node C does not include an associated biological sex. Therefore, the matched-data-link system 102 can place node C has a grandmother or grandfather. Further, the matched-data-link system 102 can place node C as a maternal grandparent or a paternal grandparent. As such, the matched-data-link system 102 performs the act 666 to generate candidate data-link trees 668, wherein each candidate data-link tree 668 represents a potential placement of node C: as maternal grandmother, maternal grandfather, paternal grandmother, and paternal grandfather of node B. In some embodiments, the matched-data-link system 102 does not generate a candidate data-link tree 668 for each potential relationship in the set relationship 664. Each candidate data-link tree 668 the matched-data-link system 102 generates during the act 666 can be used by the matched-data-link system 102 for the act 626. In some embodiments, however, the matched-data-link system 102 selects a subset of candidate data-link trees 668 to evaluate by the act 626.

As mentioned above, in certain described embodiments, the matched-data-link system 102 can generate candidate data-link trees based on the predicted relationship between a node and a placed node within an existing data-link tree. In particular, the matched-data-link system 102 can generate a candidate data-link tree for each possible permutation that represents a relationship between the node and the placed node. FIG. 6H illustrates an example diagram of perturbing a data-link tree to improve accuracy by generating alternate data-link trees in accordance with one or more embodiments.

As illustrated in FIG. 6H, the matched-data-link system 102 performs a perturbation 674 on a candidate data-link tree 672 to create a perturbed data-link tree 676. As shown, the candidate data-link tree 672 represents a data-link tree that has begun but not yet finished the tree generation and population process for a relationship cluster (e.g., as depicted in FIG. 6C). In particular, the matched-data-link system 102 can perturb data-link trees after candidate data-link trees have been generated during the act 625, during the act 628 (e.g., as part of filtering, after generating primary data-link trees), or at any stage of the tree generation and population process.

In some embodiments, the candidate data-link tree 672 includes placed nodes, depicted in the figure as numbers based on order of placement in the data-link tree (e.g., node 1 was the first node placed in the data-link tree). In one or more embodiments, the candidate data-link tree 672 includes ghost nodes, herein depicted with negative numbers (indicating order of placement). For example, the matched-data-link system 102 adds ghost nodes to the system in order to generate an accurate data-link tree. In addition, the matched-data-link system 102 performs a perturbation 674 to modify the candidate data-link tree 672 and generates a perturbed data-link tree 676 from the result. In some embodiments, one or more nodes are removed from the candidate data-link tree 672 and are no longer placed nodes in the perturbed data-link tree 676. The matched-data-link system 102 can return removed nodes back to the list of nodes to be placed and can place the nodes back into the perturbed data-link tree during subsequent iterations. In some embodiments, the removed nodes are not placed in the same location of the data-link tree during subsequent iterations.

In some embodiments, the matched-data-link system 102 performs a perturbation 674 at random, affecting edges, nodes, or both. In one or more embodiments, the matched-data-link system 102 performs a perturbation according to a defined action, such as adding, removing, or shifting a node, edge, or generation. For example, the matched-data-link system 102 can perform at least the following perturbations: detach above, detach below, move generation down, move generation up, connect nodes, and reconnect nodes. A defined perturbation may be performed in respect to a specific node, edge, or generation. For example, as depicted in FIG. 6H for perturbation 674, the matched-data-link system 102 performs a detach above perturbation for node 8. As shown, the matched-data-link system 102 removes node 8, other nodes placed in the candidate data-link tree 672 based on a relationship with node 8 (e.g., node 9 placed as a great avuncular relationship), and ghost nodes required to connect node 8 to the candidate data-link tree 672. The perturbed data-link tree 676 no longer includes ghost nodes beyond −12 and nodes 8 and 9 are disconnected. In some embodiments, the matched-data-link system 102 selects nodes or pairs of nodes at random for perturbation. In other embodiments, the matched-data-link system 102 selects nodes that keep family groups intact.

In one or more embodiments, the matched-data-link system 102 utilizes a perturbation algorithm made up of computer code defining subroutines or processes for the following functions:
Algorithm:
   Step 1: Repeating the following t times:
      Step 1.1: Remove p % of data-link tree nodes at random
         Smarter alternatives: (1) Remove edges instead; (2) Remove a whole family group; (3) Remove a ghost node (or disconnect it); (4) Instead of random removal, remove each group one at a time.
      Step 1.2: Rerun the data-link tree generation method (e.g., as depicted in FIG. 6C) until nodes are added back
         Smarter alternatives: (1) Use connect-node option of the edge selector
   Step 2: Pick the top-k from the generated candidate data-link trees
Experiment:
   Step 1: Use the top-k candidate data-link trees from the completed run
   Step 2: Run perturbation algorithm-1 for (t, p) in: {(1, 5), (1, 10), (1, 20) (10, 5), (10, 10), (10, 20)}
   Step 3: Compare the accuracy of the top-k candidate data-link trees before and after perturbation

In one or more embodiments, the matched-data-link system 102 utilizes a perturbation algorithm made up of computer code defining subroutines or processes for the following functions:
1) Calculate log-likelihood-table=of pairwise likelihoods in the data-link tree
2) Identify parent-child-candidates=child-parent pairs where the parent, child, or both, are ghost nodes.
3) Given the likelihood table, and each child c in the child-parent-candidates, calculate the ΔLikelihood between the descendants of c, and other nodes, for relationship paths that are through c
Log-likelihood_all=data-link-tree-likelihood-for-all-pairs
Log-likelihood_c_descendants=sum (log-likelihood (c_i, nc_j)) where c_i is a descendant of c, and nc_j is any node not a descendant of c
Δ log-likelihood (c)=log-likelihood_all-log-likelihood_c_descendants

As mentioned above, in certain described embodiments, the matched-data-link system 102 can perturb candidate data-link trees to improve accuracy by generating and evaluating alternative data-link trees. FIG. 6I illustrates an example diagram of filtering one or more candidate data-link trees, based on likelihood, to generate a primary data-link tree in accordance with one or more embodiments.

As illustrated in FIG. 6I, the matched-data-link system 102 can perform the act 684 to filter one or more candidate data-link trees from the set of candidate data-link tree likelihoods 682. After the act 684, the matched-data-link system 102 can generate a primary data-link tree 686 to iterate through the data-link tree generation and population process by returning the primary data-link tree 686 to the act 623 to select a next node to add. In some embodiments, the matched-data-link system 102 filters (e.g., by act 684) N number of candidate data-link tree likelihoods from the set of candidate data-link tree likelihoods 682 based on the placement likelihood values of the candidate data-link trees.

In the same or other embodiments, the matched-data-link system 102 generates more than one primary data-link tree 686. For example, the matched-data-link system 102 may select a second or third primary data-link tree 686 based on a similar placement likelihood value to the first primary data-link tree 686. Alternatively, the matched-data-link system 102 may select a primary data-link tree 686 with a lower placement likelihood value based on a different reason, such as to maintain diversity to improve subsequent results. In one or more embodiments, the matched-data-link system 102 performs the act 684 to keep a candidate data-link tree with a lower placement likelihood value to affirm or reject a node placement outside of an ideal node placement.

As mentioned above, in certain described embodiments, the matched-data-link system 102 can filter one or more candidate data-link trees into a primary data-link tree and send the primary data-link tree back to select a next node. In particular, the matched-data-link system 102 can select more than one primary data-link tree to iterate through the tree generation process. FIG. 6J illustrates an example diagram of a confusion matrix in accordance with one or more embodiments.

As illustrated in FIG. 6J, the matched-data-link system 102 can generate a confusion matrix for a data-link tree. As shown, a confusion matrix represents accuracy of a relationship between a data identifier and the nodes in a data-link tree. The accuracy of a data-link tree generated from a relationship cluster can be reviewed graphically based on patterns in the confusion matrix. For example, an ideal confusion matrix would display a deep blue line diagonal from upper left to bottom right. Patterns outside of the ideal diagonal may indicate a specific type of error in the matched-data-link system 102. In one or more embodiments, the depth of a color represents accuracy of a node placement. In the same or other embodiments, the x-axis indicates data-match level (e.g., far left represents a data-match level of 0).

FIG. 6J depicts a first confusion matrix 692 that displays a pattern with many deep blue squares on the far right of the matrix. The pattern depicted by the first confusion matrix 692 indicates that the matched-data-link system 102 is overcalling nodes as unrelated. In one or more embodiments and in response to the confusion matrix, the matched-data-link system 102 can adjust parameters to allow more leniency in the node placement process and giving nodes lower data-match levels. In contract, FIG. 6J depicts a second confusion matrix 694 that displays a pattern with scattered blue squares spread through the middle left of the matrix, indicating that the matched-data-link system 102 overcalled nodes as close relationships. In some embodiments and in response to the confusion matrix, the matched-data-link system 102 can adjust parameters to increase strictness of node placement and give nodes higher data-match levels.

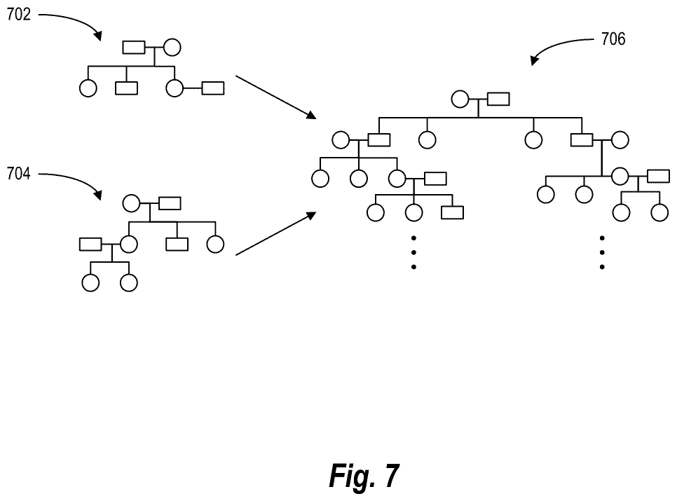

As mentioned above, in certain described embodiments, the matched-data-link system 102 can generate a confusion matrix and adjust node placement based on patterns in the confusion matrix. FIG. 7 illustrates an example diagram of combining data-link tree structures into a matched-data-link tree in accordance with one or more embodiments.

As illustrated in FIG. 7, the matched-data-link system 102 combines a data-link tree structure 702 and a data-link tree structure 704 into a matched-data-link tree 706. More specifically, the matched-data-link system 102 determines, from the data-link tree structure 702 and the data-link tree structure 704, probabilities that nodes in each of them represent common data identifiers. The matched-data-link system 102 can thus combine or merge a node in the data-link tree structure 702 with a node in the data-link tree structure 704 based on determining a merge probability (e.g., a probability that nodes in different data-link trees represent or signify the same data identifier) that satisfies a merge probability threshold. The matched-data-link system 102 can thus merge data-link tree structures. The matched-data-link system 102 can determine the merge probabilities of nodes from genetic data encoded in meiosis matches and/or relationship clusters, familial relationship data, and data-link tree structure organization. Accordingly, the matched-data-link system 102 can form the matched-data-link tree 706 that merges nodes of the discrete structures.

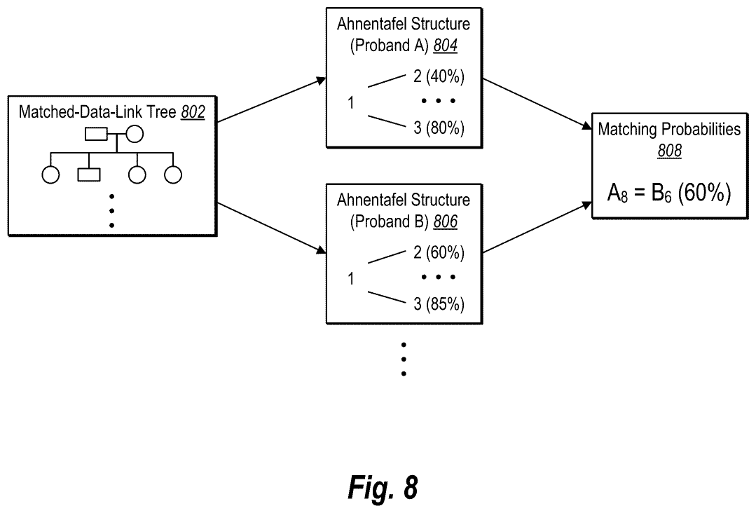

As noted above, in some embodiments, the matched-data-link system 102 can traverse a matched-data-link tree. In particular, the matched-data-link system 102 can perform matched-data-link tree traversal using a traversal algorithm. FIG. 8 illustrates an example diagram of a traversal algorithm in accordance with one or more embodiments.

As illustrated in FIG. 8, the matched-data-link system 102 accesses a matched-data-link tree 802. From the matched-data-link tree 802, the matched-data-link system 102 determines a first ahnentafel structure 804 for a first proband (proband A) and a second ahnentafel structure 806 for a second proband (proband B). Within the first ahnentafel structure 804 and the second ahnentafel structure 806, the matched-data-link system 102 determines numeric identifiers signifying relationships to a proband (e.g., 2=father, 3=mother). In some cases, the matched-data-link system 102 further determines (from genetic data, familial relationship data, and other structural data defining the matched-data-link tree data) probabilities associated with the numeric identifiers, where a probability represents a measure or a degree of confidence that the individual represented by the numeric identifier has the corresponding relationship with the proband.

The traversal algorithm can also include comparing the first ahnentafel structure 804 and the second ahnentafel structure 806 (and/or additional ahnentafel structures) to determine matching probabilities 808 across them, where a matching probability represents a measure or degree of confidence that an individual represented by one numeric value in one ahnentafel structure is the same individual represented by another numeric value in a different ahnentafel structure. As shown, the matched-data-link system 102 determines matching probabilities 808, including a 60% probability that ahnentafel 8 for proband A (As) is the same person as ahnentafel 6 for proband B (B6).

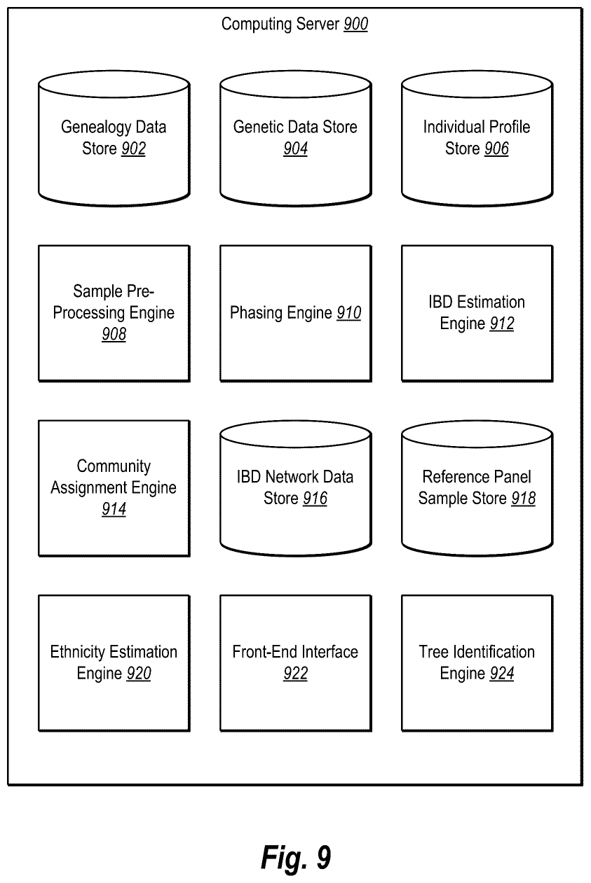

FIG. 9 is a block diagram of an architecture of an example computing server 900 (e.g., the server(s) 104), in accordance with some embodiments. In the embodiment shown in FIG. 9, the computing server 900 includes a genealogy data store 902, a genetic data store 904, an individual profile store 906, a sample pre-processing engine 908, a phasing engine 910, an identity by descent (IBD) estimation engine 912, a community assignment engine 914, an IBD network data store 916, a reference panel sample store 918, an ethnicity estimation engine 920, a front-end interface 922, and a tree identification engine 924. The functions of the computing server 900 may be distributed among the elements in a different manner than described. In various embodiments, the computing server 900 may include different components and fewer or additional components. Each of the various data stores may be a single storage device, a server controlling multiple storage devices, or a distributed network that is accessible through multiple nodes (e.g., a cloud storage system).

The computing server 900 stores various data of different individuals, including genetic data, genealogy data, and survey response data. The computing server 900 processes the genetic data of individuals (e.g., genetic profiles) to identify shared identity-by-descent (IBD) segments between individuals. The genealogy data and survey response data may be part of user account profile data. The amount and type of user account profile data stored for each individual may vary based on the information of an individual, which determined or received from the individual through creating an account and profile at a system (e.g., the genealogical-data system 106) operated by the computing server 900, and through updating the profile, family tree, and social network at the system, in some cases linking a profile with genetic data. The computing server 900 may also include answers to survey questions regarding various traits of individuals, such as phenotypes, characteristics, preferences, habits, lifestyle, and environment for user accounts.

The genealogy data store 902 may store genealogy data, including various types of data that are related to tracing family relatives of individuals. Examples of genealogy data include names (first, last, middle, suffixes), gender, birth locations, date of birth, date of death, marriage information, spouse's information, kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among user accounts of the computing server 900.

In addition to user account data, genealogy data may also take other forms that are obtained from various sources such as public records and third-party data collectors. For example, genealogical records from public sources include birth records, marriage records, death records, census records, court records, probate records, adoption records, and/or obituary records. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and/or a motor vehicle database.

Furthermore, the genealogy data store 902 may also include relationship information inferred from the genetic data stored in the genetic data store 904 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 900 maintains genetic datasets of individuals in the genetic data store 904. A genetic dataset of an individual may be a digital dataset of nucleotide data (e.g., SNP data) and corresponding metadata. A genetic dataset may contain data on the whole or portions of an individual's genome. The genetic data store 904 may store a pointer to a location associated with the genealogy data store 902 associated with the individual. A genetic dataset may take different forms. In some embodiments, a genetic dataset may take the form of a base pair sequence of the sequencing result of an individual. A base pair sequence dataset may include the whole genome of the individual (e.g., obtained from a whole-genome sequencing) or some parts of the genome (e.g., genetic loci of interest).

In another embodiment, a genetic dataset may take the form of sequences of genetic markers. Examples of genetic markers may include target SNP loci (e.g., allele sites) filtered from the sequencing results. A SNP locus that is a single base pair long may also be referred to as a SNP site. A SNP locus may be associated with a unique identifier. The genetic dataset may be in a form of diploid data that includes a sequencing of genotypes, such as genotypes at the target SNP loci, or the whole base pair sequence that includes genotypes at known SNP loci and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 904 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 906 stores profiles and related metadata associated with various individuals appearing in the computing server 900. A computing server 900 may use unique individual identifiers to identify various user accounts and other non-user accounts that might appear in other data sources such as ancestors or historical persons who appear in any family tree or genealogy database. A unique individual identifier may be a hash of certain identification information of an individual, such as a user account's account name, user account's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating genetic datasets such as genotype and phased haplotype data of the individual that are saved in the genetic data store 904. The metadata about the individual may also be individual information related to family trees and pedigree datasets that include the individual. The profile data may further include declarative information about the user account that was authorized by the user account to be shared and may also include information inferred by the computing server 900. Other examples of information stored in a user account profile may include biographic, demographic, and other types of descriptive information such as work experience, educational history, gender, hobbies, preferences, and/or location. In some embodiments, the user account profile data may also include one or more photos of the user accounts and photos of relatives (e.g., ancestors) of the user accounts that are uploaded by the user accounts. A user account may authorize the computing server 900 to analyze one or more photos to extract information, such as the user account's or relative's appearance traits (e.g., blue eyes, curved hair), from the photos. The appearance traits and other information extracted from the photos may also be saved in the profile store. In some cases, the computing server may allow user accounts to upload many different photos of the user accounts, their relatives, and even friends. User account profile data may also be obtained from other suitable sources, including historical records (e.g., records related to an ancestor), medical records, military records, photographs, other records indicating one or more traits, and other recorded data.

For example, the computing server 900 may present various survey questions to its user accounts from time to time. The responses to the survey questions may be stored at individual profile store 906. The survey questions may be related to various aspects of the user accounts and the user account families. Some survey questions may be related to user account phenotypes, while other questions may be related to environmental factors of the user accounts.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, and/or family history of causes of death. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 900 may obtain data on a user account's disease-related phenotypes from survey questions about the health history of the user account and her family and also from health records uploaded by the user account.

Survey questions also may be related to other types of phenotypes such as appearance traits of the user accounts. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to user account taste and smell such as the ability to taste bitterness, asparagus smell, and/or cilantro aversion. A survey regarding traits may further include questions related to user account body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 900 also may present various survey questions related to the environmental factors of user accounts. In this context, an environmental factor may be a factor that is not directly connected to the genetics of user accounts. Environmental factors may include user account preferences, habits, and lifestyles. For example, a survey regarding user account preferences may include questions related to things and activities that user accounts like or dislike, such as types of music a user account enjoys, dancing preference, party-going preference, certain sports that a user account plays, video game preferences, etc. Other questions may be related to diet preferences such as liking or disliking a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or does not, has a car or does not).

Surveys also may be related to other environmental factors such as geographical, social-economic, or cultural factors. Geographical questions may include questions related to the birth location, family migration history, town, or city of current or past residence. Social-economic questions may be related to education level, income, occupations, and/or self-identified demographic groups. Questions related to culture may concern native language, language spoken at home, customs, and/or dietary practices. Other questions related to cultural and behavioral questions are also possible.

For any survey questions asked, the computing server 900 may also ask an individual the same or similar questions regarding the traits and environmental factors of the ancestors, family members, other relatives or friends of the individual. For example, the computing server 900 may ask about the native language of the user account and the native languages of parents and grandparents. The computing server 900 may also ask about the health history of family members.

In addition to storing the survey data in the individual profile store 906, the computing server 900 may store some responses that correspond to data related to genealogical and genetics respectively to genealogy data store 902 and genetic data store 904.

The user account profile data, photos in user accounts, survey response data, the genetic data, and the genealogy data may be subject to the privacy and authorization setting of the user accounts to specify any data related to the user accounts that can be accessed, stored, obtained, or otherwise used. For example, when presented with a survey question, a user account may select to answer or skip the question. The computing server 900 may present user accounts from time to time information regarding user accounts' selection of the extent of information and data shared. The computing server 900 also may maintain and enforce one or more privacy settings for user accounts in connection with the access of the user account profile data, photos, genetic data, and other sensitive data. For example, the user account may pre-authorize the access to the data and may change the setting as wished. The privacy settings also may allow a user account to specify (e.g., by opting out, by not opting in) whether the computing server 900 may receive, collect, log, or store particular data associated with the user account for any purpose. A user account may restrict her data at various levels. For example, on one level, the data may not be accessed by the computing server 900 for purposes other than displaying the data in the user account's own profile. On another level, the user account may authorize anonymization of her data and participate in studies and research conducted by the computing server 900 such as a large-scale genetic study. On yet another level, the user account may turn some portions of her genealogy data public to allow the user account to be discovered by other user accounts (e.g., potential relatives) and be connected to one or more family trees. Access or sharing of any information or data in the computing server 900 may also be subject to one or more similar privacy policies. Data and content objects in the computing server 900 may also be associated with different levels of restriction. The computing server 900 may also provide various notification features to inform and remind user accounts of their privacy and access settings. For example, when privacy settings for a data entry allow a particular user account or other entities to access the data, the data may be described as being “visible,” “public,” or other suitable labels, contrary to a “private” label.

In some cases, the computing server 900 may have a heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 900 may provide the heightened privacy as a default setting for certain types of data, such as genetic data or any data that the user account marks as sensitive. The user account may opt in to sharing of those data or change the default privacy settings. In other cases, the heightened privacy settings may apply across the board for all data of certain groups of user accounts. For example, if computing server 900 determines that the user account is a minor or has recognized that a picture of a minor is uploaded, the computing server 900 may designate all profile data associated with the minor as sensitive. In those cases, the computing server 900 may have one or more extra steps in seeking and confirming any sharing or use of the sensitive data.

The sample pre-processing engine 908 receives and pre-processes data received from various sources to change the data into a format used by the computing server 900. For genealogy data, the sample pre-processing engine 908 may receive data from an individual. To collect the user account data (e.g., genealogical and survey data), the computing server 900 may cause an interactive user account interface on a client device to display interface elements in which user accounts can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, and/or death certificates.

The sample pre-processing engine 908 may also receive raw data from a genetic data extraction service server. A genetic data extraction service server may perform laboratory analysis of biological samples of user accounts and generate sequencing results in the form of digital data. The sample pre-processing engine 908 may receive the raw genetic datasets from the genetic data extraction service server. Most of the mutations that are passed down to descendants are related to single-nucleotide polymorphism (SNP). A SNP is a substitution of a single nucleotide that occurs at a specific position in the genome. The sample pre-processing engine 908 may convert the raw base pair sequence into a sequence of genotypes of target SNP sites. Alternatively, the pre-processing of this conversion may be performed by the genetic data extraction service server. The sample pre-processing engine 908 identifies autosomal SNPs in an individual's genetic dataset. In some embodiments, the SNPs may be autosomal SNPs. In some embodiments, 700,000 SNPs may be identified in an individual's data and may be stored in genetic data store 904. Alternatively, in some embodiments, a genetic dataset may include at least 10,000 SNP sites. In another embodiment, a genetic dataset may include at least 100,000 SNP sites. In yet another embodiment, a genetic dataset may include at least 300,000 SNP sites. In yet another embodiment, a genetic dataset may include at least 1,000,000 SNP sites. The sample pre-processing engine 908 may also convert the nucleotides into bits. The identified SNPs, in bits or in other suitable formats, may be provided to the phasing engine 910 which phases the individual's diploid genotypes to generate a pair of haplotypes for each user account.

The phasing engine 910 phases diploid genetic dataset into a pair of haploid genetic datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to sequencing conditions and other constraints, a sequencing result often includes data regarding a pair of alleles at a given SNP locus of a pair of chromosomes but may not be able to distinguish which allele belongs to which specific chromosome. The phasing engine 910 uses a genotype phasing algorithm to assign one allele to a first chromosome and another allele to another chromosome. The genotype phasing algorithm may be developed based on an assumption of linkage disequilibrium (LD), which states that haplotypes, in the form of a sequence of alleles, tend to cluster together. The phasing engine 910 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio may be used as a training sample because the correct phasing of the child is almost certain by comparing the child's genotypes to the parent's genetic datasets. The haplotype-cluster model may be generated iteratively along with the phasing process with a large number of unphased genotype datasets. The haplotype-cluster model may also be used to impute one or more missing data.

By way of example, the phasing engine 910 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 910 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing. Other example phasing embodiments are described in U.S. Patent Application Publication No. US 2021/0034647, entitled “Clustering of Matched Segments to Determine Linkage of Dataset in a Database,” published on Feb. 4, 2021.

The IBD estimation engine 912 estimates the amount of shared genetic segments between a pair of individuals based on phased genotype data (e.g., haplotype datasets) that are stored in the genetic data store 904. IBD segments may be segments identified in a pair of individuals that are putatively determined to be inherited from a common ancestor. The IBD estimation engine 912 retrieves a pair of haplotype datasets for each individual. The IBD estimation engine 912 may divide each haplotype dataset sequence into a plurality of windows. Each window may include a fixed number of SNP sites (e.g., about 100 SNP sites). The IBD estimation engine 912 identifies one or more seed windows in which the alleles at all SNP sites in at least one of the phased haplotypes between two individuals are identical. The IBD estimation engine 912 may expand the match from the seed windows to nearby windows until the matched windows reach the end of a chromosome or until a homozygous mismatch is found, which indicates the mismatch is not attributable to potential errors in phasing or imputation. The IBD estimation engine 912 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 900 may save data regarding individual pairs who share a length of IBD segments exceeding a predetermined threshold (e.g., 6 cM), in a suitable data store such as in the genealogy data store 902. U.S. Pat. No. 10,114,922, entitled “Identifying Ancestral Relationships Using a Continuous Stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 914 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish immigrated to America in 1800, Irish immigrated to America in 1902, etc. The community classification may also depend on whether a population is admixed or unadmixed. For an admixed population, the classification may further be divided based on different ethnic origins in a geographical region.

Community assignment engine 914 may assign individuals to one or more genetic communities based on their genetic datasets using machine learning models trained by unsupervised learning or supervised learning. In an unsupervised approach, the community assignment engine 914 may generate data representing a partially connected undirected graph. In this approach, the community assignment engine 914 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 914 uses clustering techniques such as modularity measurement (e.g., the Louvain method) to classify nodes into different clusters in the IBD network. Each cluster may represent a community. The community assignment engine 914 may also determine sub-clusters, which represent sub-communities. The computing server 900 saves the data representing the IBD network and clusters in the IBD network data store 916. U.S. Pat. No. 10,223,498, entitled “Discovering Population Structure from Patterns of Identity-By-Descent,” granted on Mar. 5, 2019, describes example embodiments of community detection and assignment.

The community assignment engine 914 may also assign communities using supervised techniques. For example, genetic datasets of known genetic communities (e.g., individuals with confirmed ethnic origins) may be used as training sets that have labels of the genetic communities. Supervised machine learning classifiers, such as logistic regression, support vector machines, random forest classifiers, and neural networks may be trained using the training set with labels. A trained classifier may distinguish binary or multiple classes. For example, a binary classifier may be trained for each community of interest to determine whether a target individual's genetic dataset belongs or does not belong to the community of interest. A multi-class classifier such as a neural network may also be trained to determine whether the target individual's genetic dataset most likely belongs to one of several possible genetic communities.

Reference panel sample store 918 stores reference panel samples for different genetic communities. A reference panel sample is the genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some genetic datasets include alleles that are commonly present among members of the community. Reference panel samples may be used to train various machine learning models in classifying whether a target genetic dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., contains fewer than 1000 nodes). For example, the community assignment engine 914 may construct a full IBD network that includes a set of individuals represented by nodes and generate communities using clustering techniques. The community assignment engine 914 may randomly sample a subset of nodes to generate a sampled IBD network. The community assignment engine 914 may recursively apply clustering techniques to generate communities in the sampled IBD network. The sampling and clustering may be repeated for different randomly generated sampled IBD networks for various runs. Nodes that are consistently assigned to the same genetic community when sampled in various runs may be classified as a reference panel sample. The community assignment engine 914 may measure the consistency in terms of a predetermined threshold. For example, if a node is classified to the same community 95% (or another suitable threshold) of the times whenever the node is sampled, the genetic dataset corresponding to the individual represented by the node may be regarded as a reference panel sample. Additionally, or alternatively, the community assignment engine 914 may select N most consistently assigned nodes as a reference panel for the community.

Other ways to generate reference panel samples are also possible. For example, the computing server 900 may collect a set of samples and gradually filter and refine the samples until high-quality reference panel samples are selected. For example, a candidate reference panel sample may be selected from an individual whose recent ancestors are born at a certain birthplace. The computing server 900 may also draw sequence data from the Human Genome Diversity Project (HGDP). Various candidates may be manually screened based on their family trees, relatives' birth location, and other quality control. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 920 estimates the ethnicity composition of a genetic dataset of a target individual. The genetic datasets used by the ethnicity estimation engine 920 may be genotype datasets or haplotype datasets. For example, the ethnicity estimation engine 920 estimates the ancestral origins (e.g., ethnicity) based on the individual's genotypes or haplotypes at the SNP sites. To take a simple example of three ancestral populations corresponding to African, European, and Native American, an admixed user account may have nonzero estimated ethnicity proportions for all three ancestral populations, with an estimate such as [0.05, 0.65, 0.30], indicating that the user account's genome is 5% attributable to African ancestry, 65% attributable to European ancestry, and 30% attributable to Native American ancestry. The ethnicity estimation engine 920 generates the ethnic composition estimate and stores the estimated ethnicities in a data store of computing server 900 with a pointer in association with a particular user account.

In some embodiments, the ethnicity estimation engine 920 divides a target genetic dataset into a plurality of windows (e.g., about 1000 windows). Each window includes a small number of SNPs (e.g., 300 SNPs). The ethnicity estimation engine 920 may use a directed acyclic graph model to determine the ethnic composition of the target genetic dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 920 determines the emission probabilities by comparing SNPs in the window corresponding to the target genetic dataset to corresponding SNPs in the windows in various reference panel samples of different genetic communities stored in the reference panel sample store 918. The transition probability between two nodes represents the likelihood of transition from one node to another across two levels. The ethnicity estimation engine 920 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 920 determines the ethnic composition of the target genetic dataset by determining the label compositions of the nodes that are included in the determined path. U.S. Pat. No. 10,558,930, entitled “Local Genetic Ethnicity Determination System,” granted on Feb. 11, 2020 and U.S. Pat. No. 10,692,587, granted on Jun. 23, 2020, entitled “Global Ancestry Determination System” describe different example embodiments of ethnicity estimation.

The front-end interface 922 displays various results determined by the computing server 900. The results and data may include the IBD affinity between a user account and another individual, the community assignment of the user account, the ethnicity estimation of the user account, phenotype prediction and evaluation, genealogy data search, family tree and pedigree, relative profile and other information. The front-end interface 922 may allow user accounts to manage their profile and data trees (e.g., family trees). The user accounts may view various public family trees stored in the computing server 900 and search for individuals and their genealogy data via the front-end interface 922. The computing server 900 may suggest or allow the user account to manually review and select potentially related individuals (e.g., relatives, ancestors, close family members) to add to the user account's data tree. The front-end interface 922 may be a graphical user account interface (GUI) that displays various information and graphical elements. The front-end interface 922 may take different forms. In one case, the front-end interface 922 may be a software application that can be displayed on an electronic device such as a computer or a smartphone. The software application may be developed by the entity controlling the computing server 900 and be downloaded and installed on the client device 108. In another case, the front-end interface 922 may take the form of a webpage interface of the computing server 900 that allows user accounts to access their family tree and genetic analysis results through web browsers. In yet another case, the front-end interface 922 may provide an application program interface (API).

The tree identification engine 924 performs computations and other processes related to user accounts' management of their data trees such as family trees. The tree identification engine 924 may allow a user account to build a data tree from scratch or to link the user account to existing data trees. In some embodiments, the tree identification engine 924 may suggest a connection between a target individual and a family tree that exists in the family tree database by identifying potential family trees for the target individual and identifying one or more most probable positions in a potential family tree. A user account (target individual) may wish to identify family trees to which he or she may potentially belong. Linking a user account to a family tree or building a family may be performed automatically, manually, or using techniques with a combination of both. In an embodiment of an automatic tree matching, the tree identification engine 924 may receive a genetic dataset from the target individual as input and search related individuals that are IBD-related to the target individual. The tree identification engine 924 may identify common ancestors. Each common ancestor may be common to the target individual and one of the related individuals. The tree identification engine 924 may in turn output potential family trees to which the target individual may belong by retrieving family trees that include a common ancestor and an individual who is IBD-related to the target individual. The tree identification engine 924 may further identify one or more probable positions in one of the potential family trees based on information associated with matched genetic data between the target individual and DNA test takers in the potential family trees through one or more machine learning models or other heuristic algorithms. For example, the tree identification engine 924 may try putting the target individual in various possible locations in the family tree and determine the highest probability position(s) based on the genetic datasets of the target individual and other DNA test takers in the family tree and based on genealogy data available to the tree identification engine 924. The tree identification engine 924 may provide one or more family trees from which the target individual may select. For a suggested family tree, the tree identification engine 924 may also provide information on how the target individual is related to other individuals in the tree. In a manual tree building, a user account may browse through public family trees and public individual entries in the genealogy data store 902 and individual profile store 906 to look for potential relatives that can be added to the user account's family tree. The tree identification engine 924 may automatically search, rank, and suggest individuals for the user account conduct manual reviews as the user account makes progress in the front-end interface 922 in building the family tree.

As used herein, “data-link tree” and “family tree” may be interchangeable and may refer to a family tree chart or data-link tree chart that shows, diagrammatically, family information, such as data-identifier origination information (e.g., family history), including parentage, offspring, spouses, siblings, or otherwise for any suitable number of generations and/or people, and/or data pertaining to persons represented in the chart. U.S. Pat. No. 11,429,615, entitled “Linking Individual Datasets to a Database,” granted on Aug. 30, 2022, describes example embodiments of how an individual may be linked to existing family trees.

The components of the matched-data-link system 102 can include software, hardware, or both. For example, the components of the matched-data-link system 102 can include one or more instructions stored on a computer-readable storage medium and executable by processors of one or more computing devices. When executed by one or more processors, the computer-executable instructions of the matched-data-link system 102 can cause a computing device to perform the methods described herein. Alternatively, the components of the matched-data-link system 102 can comprise hardware, such as a special purpose processing device to perform a certain function or group of functions. Additionally or alternatively, the components of the matched-data-link system 102 can include a combination of computer-executable instructions and hardware.

Furthermore, the components of the matched-data-link system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the matched-data-link system 102 may be implemented as part of a stand-alone application on a personal computing device or a mobile device.

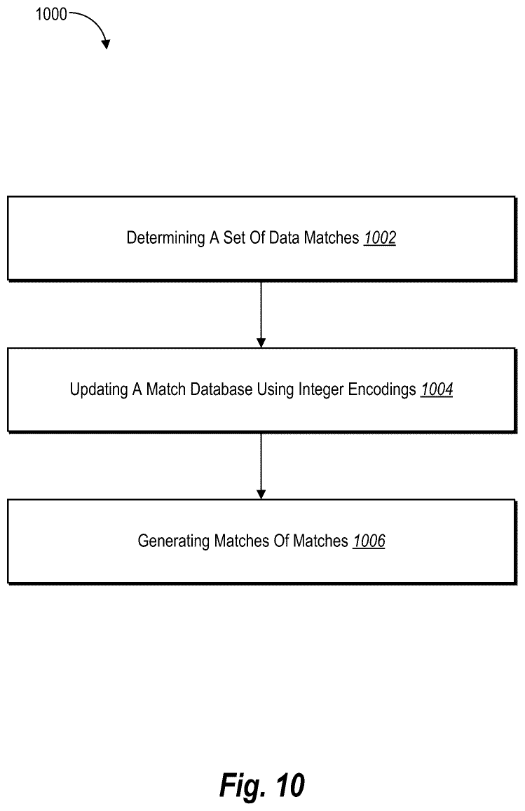

FIGS. 1-9, the corresponding text, and the examples provide a number of different systems and methods for generating a matched-data-link tree in accordance with one or more embodiments. In addition to the foregoing, implementations can also be described in terms of flowcharts comprising acts or steps in a method for accomplishing a particular result. For example, FIGS. 10-15 illustrate example series of acts for various constituent processes involved in generating a matched-data-link tree.

While FIGS. 10-15 illustrates acts according to certain implementations, alternative implementations may omit, add to, reorder, and/or modify any of the acts shown in FIGS. 10-15. The acts of FIGS. 10-15 can be performed as part of a method. Alternatively, a non-transitory computer-readable medium can comprise instructions, that when executed by one or more processors, cause a computing device to perform the acts of FIGS. 10-15. In still further implementations, a system can perform the acts of FIGS. 10-15.

As illustrated in FIG. 10, the series of acts 1000 may include an act 1002 of determining a set of data matches. In particular, the act 1002 can involve determining, for a data identifier, a set of data matches across a plurality of data-match levels. The series of acts 1000 can also include an act 1004 of updating a match database using integer encodings. In particular, the act 1004 can involve updating a match database to include the set of data matches for the data identifier by adding a set of integers encoding the set of data matches, wherein the match database comprises a table of rows representing data identifiers such that a row in the table includes integers defining data matches for a respective data identifier. The series of acts 1000 can include an act 1006 of generating matches of matches. In particular, the act 1006 can involve generating a matches-of-matches prediction for the data identifier by querying the match database for integers in rows corresponding to the set of data matches of the data identifier.

In some embodiments, the series of acts 1000 can include an act of generating the matches-of-matches prediction by determining, for the data identifier, a matches-of-matches set comprising data matches of data matches corresponding to the data identifier. The series of acts 1000 can also include an act of generating, utilizing one or more relationship prediction models to process the matches-of-matches set, relationship predictions indicating types of data links among the matches-of-matches set. Further, the series of acts 1000 may include an act of generating, for the data identifier, a relationship cluster from the relationship predictions using a relationship clustering algorithm.

In some embodiments, the series of acts 1000 includes an act of generating the relationship cluster from the relationship predictions using the relationship clustering algorithm by examining, for a candidate relationship cluster, edges between data identifiers in the relationship cluster; calculating connectivity values for the data identifiers based on examining the edges; and removing at least one data identifier from the candidate relationship cluster according to the connectivity values. In one or more embodiments, the series of acts 1000 may include an act of calculating the connectivity values for the data identifiers by determining, by comparing a first data identifier with the other data identifiers in the candidate relationship cluster, a quantity of matches that the first data identifier has with the other data identifiers in the candidate relationship cluster; and calculating a connectivity value for the first data identifier by comparing the quantity of matches for the first data identifier with the total number of the other data identifiers in the candidate relationship cluster.

In some embodiments, the series of acts 1000 includes an act of generating, by removing the at least one data identifier from the relationship cluster, the relationship cluster as a filtered relationship cluster. In one or more embodiments, the series of acts 1000 may include an act of determining data matches from the set of data matches that exceed a threshold data-match level. In one or more embodiments, the series of acts 1000 further includes an act of separating a first subset of data matches from the set of data matches into a first category corresponding to a first data-match level; separating a second subset of data matches from the set of data matches into a second category corresponding to a second data-match level; and removing the data matches from the set of data matches that exceed the threshold data-match level. Further, the series of acts 1000 may include determining the matches-of-matches set by intersecting the first subset of data matches in the first category with the second subset of data matches in the second category.

In some embodiments, the series of acts 1000 can include an act of generating match clusters for the matches-of-matches set utilizing a set of clustering methods comprising Louvain community detection, spectral clustering, and agglomerative hierarchical clustering. In one or more embodiments, the series of acts 1000 includes an act of filtering the match clusters for the matches-of-matches set by connectivity value and threshold data-match level. In the same or other embodiments, the series of acts 1000 can include an act of refining the match clusters for the matches-of-matches set by repeating, for multiple iterations: clustering the match clusters for the matches-of-matches set using the set of clustering methods; and filtering the match clusters for the matches-of-matches set by connectivity and threshold data-match level, wherein the connectivity and threshold data-match level vary for each iteration. Further, the series of acts 1000 can include an act of providing the matches-of-matches prediction to a match calculator.

In some embodiments, the series of acts 1000 can include an act of generating, by the match calculator, additional match data for the matches-of-matches prediction; and utilizing the additional match data to generate a relationship cluster. In one or more embodiments, the series of acts 1000 includes storing the integers by converting the integers into an array of bytes; and, upon receiving a request for an integer from the integers, converting the array of bytes back into the integer. In the same or other embodiments, the series of acts 1000 may include an act of generating, for display within a graphical user interface of a client device, a relationship cluster diagram. In some embodiments, the series of acts 1000 includes an act of removing one or more data matches from the set of data matches according to a data link type associated with the data identifier.

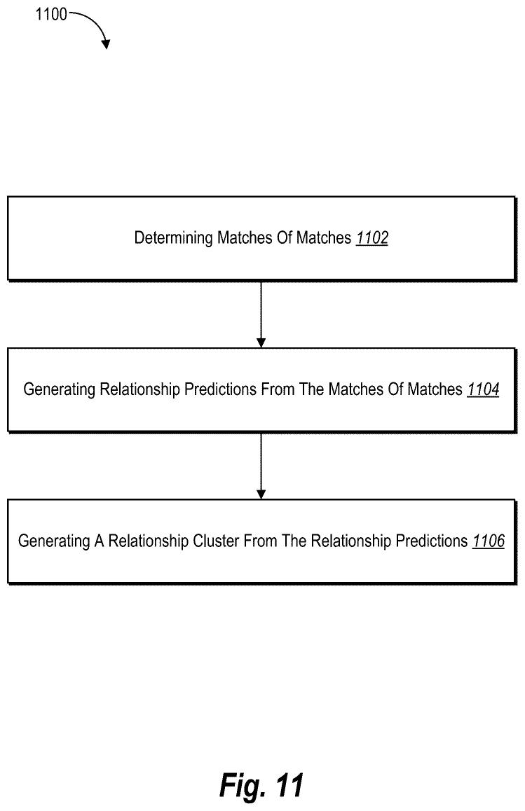

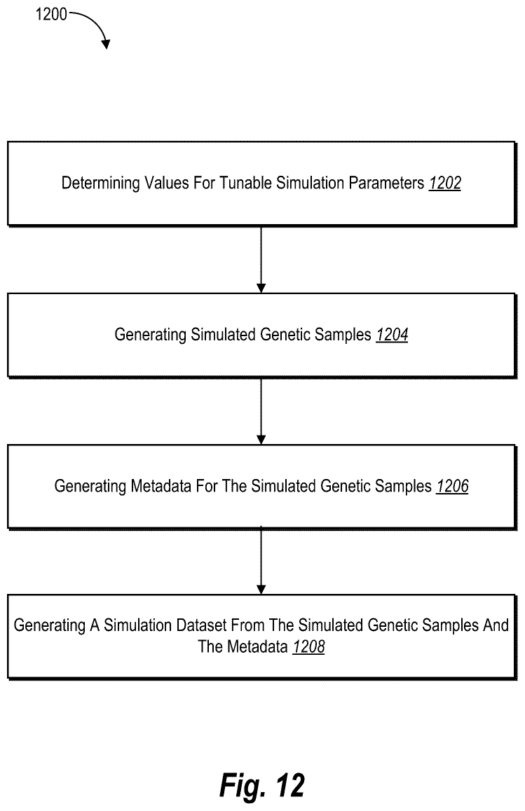

As illustrated in FIG. 11, the series of acts 1100 includes an act 1102 of determining matches of matches, an act 1104 of generating relationship predictions from the matches of matches, and an act 1106 of generating a relationship cluster from the relationship predictions. As illustrated in FIG. 12, the series of acts 1200 includes an act 1202 of determining values for tunable simulation parameters, an act 1204 of generating simulated genetic samples, an act 1206 of generating metadata for the simulated genetic samples, and an act 1208 of generating a simulation dataset from the simulated genetic samples and the metadata.

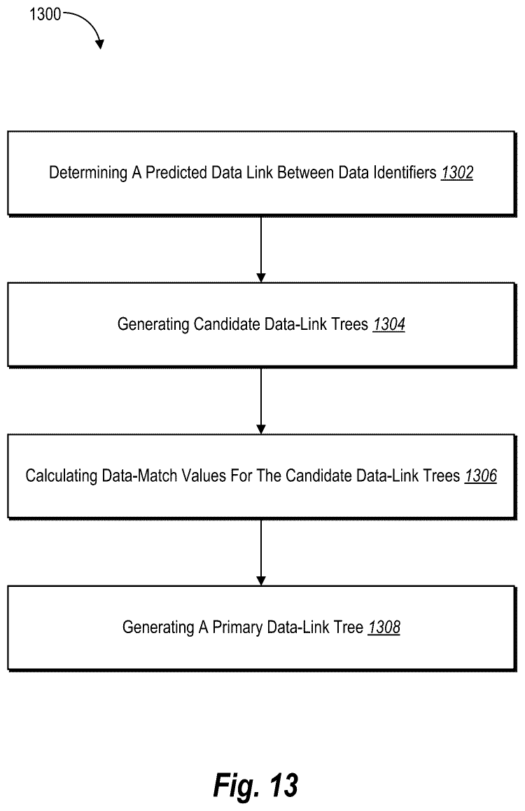

As illustrated in FIG. 13, the series of acts 1300 includes an act 1302 of determining a predicted data link between data identifiers. In particular, the act 1302 can involve determining, for a first data identifier and a second data identifier within a relationship cluster comprising a plurality of data identifiers grouped according to data matches, a predicted data link between the first data identifier and the second data identifier. The series of acts 1300 can also include an act 1304 of generating candidate data-link trees. In particular, the act 1304 can involve generating, based on the predicted data link, a first candidate data-link tree and a second candidate data-link tree, wherein the first candidate data-link tree comprises a first connection between a first node representing the first data identifier and a second node representing the second data identifier and wherein the second candidate data-link tree comprises a second connection between the first node and the second node. The series of acts 1300 can also include an act 1306 of calculating data-match values for the candidate data-link trees. In particular, the act 1306 can involve calculating a first data-match value for the first candidate data-link tree and a second data-match value for the second candidate data-link tree. The series of acts 1300 can also include an act 1308 of generating a primary data-link tree. In particular, the act 1308 can involve, based on comparing the first data-match value and the second data-match value, generating a primary data-link tree including the first node and the second node arranged according to the first connection reflected by the first candidate data-link tree.

In some embodiments, the series of acts 1300 can include an act of generating additional primary data-link trees by generating, over multiple iterations, candidate data-link trees reflecting different possible connections between data identifiers in the relationship cluster. The series of acts 1300 can also include an act of merging the primary data-link tree and the additional primary data-link trees to form a universal data-link tree arranging the data identifiers in the relationship cluster according to data matches. Further, the series of acts 1300 may include an act wherein the first node is a placed node within the primary data-link tree and generating the first candidate data-link tree and the second candidate data link tree includes: generating, from the first connection between the placed node and the second data identifier, the first candidate data-link tree; and generating, from the second connection between the placed node and the second data identifier, the second candidate data-link tree. In one or more embodiments, the series of acts 1300 can include an act of wherein calculating the first data-match value and the second data-match value includes calculating, based on a likelihood distribution and a negative log likelihood calculation, the first data-match value for the first candidate data-link tree and the second data-match value for the second candidate data-link tree.

In some embodiments, the series of acts 1300 can include an act of filtering among the primary data-link tree and the additional primary data-link trees by comparing data-match values of the primary data link tree and the additional primary data-link trees. The series of acts 1300 can also include an act of wherein generating the primary data-link tree inlcudes generating more than one primary data-link tree by: generating a first primary data-link tree including the first node and the second node arranged according to the first connection reflected by the first candidate data-link tree; and generating a second primary data-link tree including the first node and the second node arranged according to the second connection reflected by the second candidate data-link tree. Further, the series of acts 1300 may include an act of selecting the second data identifier from the relationship cluster according to at least one of shared centimorgans with the first data identifier, a number of segments shared with the first data identifier, or metadata associated with the second data identifier. In one or more embodiments, the series of acts 1300 can include an act of associating more than one data-link type with the predicted data link.

In some embodiments, the series of acts 1300 can include an act of generating the first candidate data-link tree according to a first data-link type; and generating the second candidate data-link tree according to a second data-link type. The series of acts 1300 can also include an act of generating, within the first candidate data-link tree and the second candidate data-link tree, a ghost node for a node connecting the first data identifier and the second data identifier, wherein the ghost node represents an unknown data identifier. Further, the series of acts 1300 may include an act of utilizing, according to the predicted data link, a first method to calculate a data-match value within a threshold and utilize a second method to calculate a data-value outside of the threshold. In one or more embodiments, the series of acts 1300 can include an act of utilizing a machine learning model to determine the predicted data link.

In some embodiments, the series of acts 1300 can include an act of generating, for display with a graphical user interface of a client device, a confusion matrix, wherein the confusion matrix depicts prediction accuracy across a plurality of data-match levels by: comparing a predicted data link between a placed node and a proband in the primary data-link tree with an actual data link between the placed node and the proband; calculating an accuracy value for the predicted data link based on the actual data link; and graphing the predicted data link within the confusion matrix according to data-match level and depicting the accuracy value. The series of acts 1300 can also include an act of adjusting, according to the confusion matrix, how to determine the predicted data link; and determining an adjusted predicted data link. Further, the series of acts 1300 may include an act of evaluating the primary data-link tree for double relationships, underrepresentation of infrequently occurring data links, and endogamy. In one or more embodiments, the series of acts 1300 can include an act of generating an alternate primary data-link tree by perturbing the first candidate data-link tree. In addition, the series of acts 1330 can include an act of perturbing the first candidate data-link tree by adding or removing an edge between nodes at random.

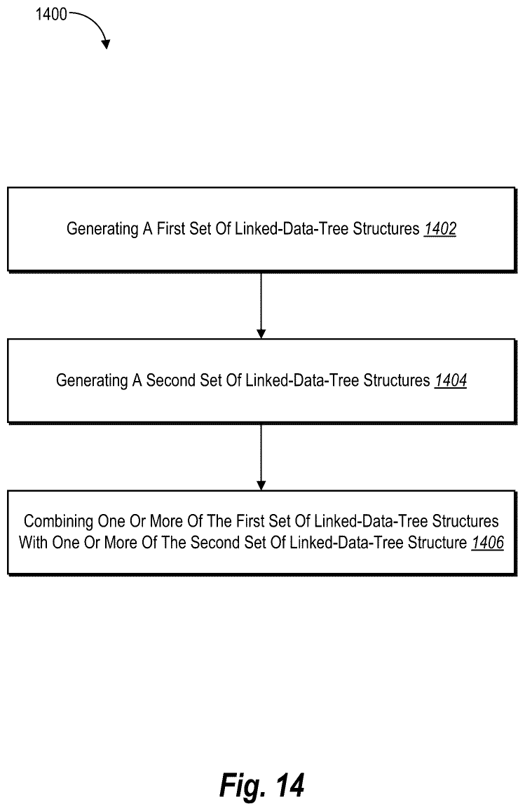

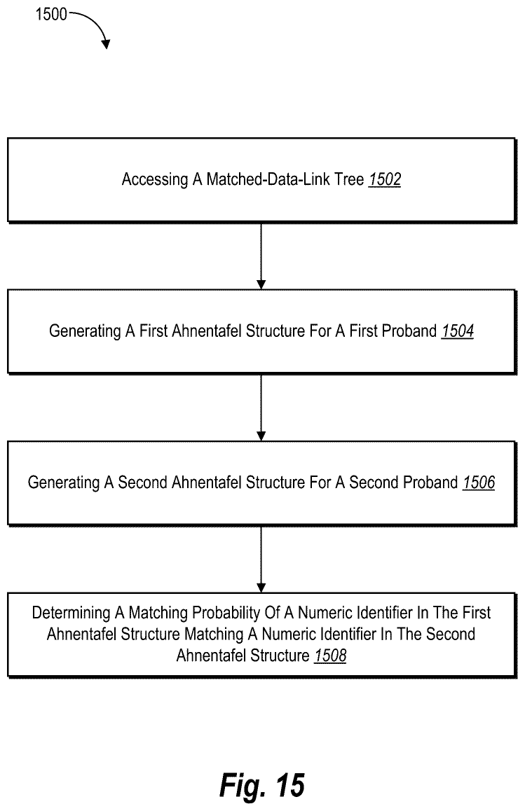

As illustrated in FIG. 14, the series of acts 1400 includes an act 1402 of generating a first set of data-link-tree structures, an act 1404 of generating a second set of data-link-tree structures, and an act 1406 of combining one or more of the first set of data-link-tree structures with one or more of the second set of data-link-tree structures. As illustrated in FIG. 15, the series of acts 1500 includes an act 1502 of accessing a matched-data-link tree, an act 1504 of generating a first ahnentafel structure for a first proband, an act 1506 of generating a second ahnentafel structure for a second proband, and an act 1508 of determining a matching probability of a numeric identifier in the first ahnentafel structure matching a numeric identifier in the second ahnentafel structure.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 16 illustrates a block diagram of exemplary computing device 1600 (e.g., the server(s) 104, the computing server 900, and/or the client device 108) that may be configured to perform one or more of the processes described above. One will appreciate that server(s) 104 and/or the client device 108 may comprise one or more computing devices such as computing device 1600. As shown by FIG. 16, computing device 1600 can comprise processor 1602, memory 1604, storage device 1606, I/O interface 1608, and communication interface 1610, which may be communicatively coupled by way of communication infrastructure 1612. While an exemplary computing device 1600 is shown in FIG. 16, the components illustrated in FIG. 16 are not intended to be limiting. Additional or alternative components may be used in other implementations. Furthermore, in certain implementations, computing device 1600 can include fewer components than those shown in FIG. 16. Components of computing device 1600 shown in FIG. 16 will now be described in additional detail.

In particular implementations, processor 1602 includes hardware for executing instructions, such as those making up a computer program. As an example and not by way of limitation, to execute instructions, processor 1602 may retrieve (or fetch) the instructions from an internal register, an internal cache, memory 1604, or storage device 1606 and decode and execute them. In particular implementations, processor 1602 may include one or more internal caches for data, instructions, or addresses. As an example and not by way of limitation, processor 1602 may include one or more instruction caches, one or more data caches, and one or more translation lookaside buffers (TLBs). Instructions in the instruction caches may be copies of instructions in memory 1604 or storage device 1606.

Memory 1604 may be used for storing data, metadata, and programs for execution by the processor(s). Memory 1604 may include one or more of volatile and non-volatile memories, such as Random Access Memory (“RAM”), Read Only Memory (“ROM”), a solid-state drive (“SSD”), Flash, Phase Change Memory (“PCM”), or other types of data storage. Memory 1604 may be internal or distributed memory.

Storage device 1606 includes storage for storing data or instructions. As an example and not by way of limitation, storage device 1606 can comprise a non-transitory storage medium described above. Storage device 1606 may include a hard disk drive (HDD), a floppy disk drive, flash memory, an optical disc, a magneto-optical disc, magnetic tape, or a Universal Serial Bus (USB) drive or a combination of two or more of these. Storage device 1606 may include removable or non-removable (or fixed) media, where appropriate. Storage device 1606 may be internal or external to computing device 1600. In particular implementations, storage device 1606 is non-volatile, solid-state memory. In other implementations, Storage device 1606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1608 allows a user to provide input to, receive output from, and otherwise transfer data to and receive data from computing device 1600. I/O interface 1608 may include a mouse, a keypad or a keyboard, a touch screen, a camera, an optical scanner, network interface, modem, other known I/O devices or a combination of such I/O interfaces. I/O interface 1608 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1608 is configured to provide graphical data to a display for presentation to a user. The graphical data may be representative of one or more graphical user interfaces and/or any other graphical content as may serve a particular implementation.

Communication interface 1610 can include hardware, software, or both. In any event, communication interface 1610 can provide one or more interfaces for communication (such as, for example, packet-based communication) between computing device 1600 and one or more other computing devices or networks. As an example and not by way of limitation, communication interface 1610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1612 may include hardware, software, or both that couples components of computing device 1600 to each other. As an example and not by way of limitation, communication infrastructure 1612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 17 is a schematic diagram illustrating environment 1700 within which one or more implementations of the matched-data-link system 102 can be implemented. For example, the matched-data-link system 102 may be part of a genealogical-data system 1702 (e.g., the genealogical-data system 106). The genealogical-data system 1702 may generate, store, manage, receive, and send digital content (such as genealogical content items). For example, genealogical-data system 1702 may send and receive digital content to and from a user client device 1706 by way of network 1704. In particular, genealogical-data system 1702 can store and manage genealogical databases for various user accounts, historical records, and data-tree structures. In some embodiments, the genealogical-data system 1702 can manage the distribution and sharing of digital content between computing devices associated with user accounts. For instance, the genealogical-data system 1702 can facilitate a user account sharing a genealogical content item with another user account of genealogical-data system 1702.

In particular, the genealogical-data system 1702 can manage synchronizing digital content across multiple user client devices 1706 associated with one or more user accounts. For example, a user may edit a digitized historical document or a node within a data-tree structure using user client device 1706. The genealogical-data system 1702 can cause user client device 1706 to send the edited genealogical content to the genealogical-data system 1702, whereupon the genealogical-data system 1702 synchronizes the genealogical content on one or more additional computing devices.

As shown, the user client device 1706 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The user client device 1706 may execute one or more client applications, such as a web browser (e.g., Microsoft Windows Internet Explorer, Mozilla Firefox, Apple Safari, Google Chrome, Opera) or a native or special-purpose client application (e.g., Ancestry: Family History & DNA for iPhone or iPad, Ancestry: Family History & DNA for Android), to access and view content over the network 1704.

The network 1704 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which a user client device 1706 may access genealogical-data system 1702.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, for a first data identifier and a second data identifier within a relationship cluster comprising a plurality of data identifiers grouped according to data matches, a predicted data link between the first data identifier and the second data identifier;
generating, based on the predicted data link, a first candidate data-link tree and a second candidate data-link tree, wherein the first candidate data-link tree comprises a first connection between a first node representing the first data identifier and a second node representing the second data identifier and wherein the second candidate data-link tree comprises a second connection between the first node and the second node;
calculating a first data-match value for the first candidate data-link tree and a second data-match value for the second candidate data-link tree; and
based on comparing the first data-match value and the second data-match value, generating a primary data-link tree including the first node and the second node arranged according to the first connection reflected by the first candidate data-link tree.

2. The computer-implemented method of claim 1, further comprising generating additional primary data-link trees by generating, over multiple iterations, candidate data-link trees reflecting different possible connections between data identifiers in the relationship cluster.

3. The computer-implemented method of claim 2, further comprising merging the primary data-link tree and the additional primary data-link trees to form a universal data-link tree arranging the data identifiers in the relationship cluster according to data matches.

4. The computer-implemented method of claim 1, wherein the first node is a placed node within the primary data-link tree and generating the first candidate data-link tree and the second candidate data link tree further comprises:
generating, from the first connection between the placed node and the second data identifier, the first candidate data-link tree; and
generating, from the second connection between the placed node and the second data identifier, the second candidate data-link tree.

5. The computer-implemented method of claim 4, wherein calculating the first data-match value and the second data-match value further comprises calculating, based on a likelihood distribution and a negative log likelihood calculation, the first data-match value for the first candidate data-link tree and the second data-match value for the second candidate data-link tree.

6. The computer-implemented method of claim 2, further comprising filtering among the primary data-link tree and the additional primary data-link trees by comparing data-match values of the primary data link tree and the additional primary data-link trees.

7. The computer-implemented method of claim 1, wherein generating the primary data-link tree comprises generating more than one primary data-link tree by:
generating a first primary data-link tree including the first node and the second node arranged according to the first connection reflected by the first candidate data-link tree; and
generating a second primary data-link tree including the first node and the second node arranged according to the second connection reflected by the second candidate data-link tree.

8. A non-transitory computer readable medium storing instructions which, when executed by at least one processor, cause the at least one processor to:
determine, for a first data identifier and a second data identifier within a relationship cluster comprising a plurality of data identifiers grouped according to data matches, a predicted data link between the first data identifier and the second data identifier;
generate, based on the predicted data link, a first candidate data-link tree and a second candidate data-link tree, wherein the first candidate data-link tree comprises a first connection between a first node representing the first data identifier and a second node representing the second data identifier and wherein the second candidate data-link tree comprises a second connection between the first node and the second node;
calculate a first data-match value for the first candidate data-link tree and a second data-match value for the second candidate data-link tree; and
based on comparing the first data-match value and the second data-match value, generate a primary data-link tree including the first node and the second node arranged according to the first connection reflected by the first candidate data-link tree.

9. The non-transitory computer readable medium of claim 8, further comprising instructions which, when executed by the at least one processor, cause the at least one processor to select the second data identifier from the relationship cluster according to at least one of shared centimorgans with the first data identifier, a number of segments shared with the first data identifier, or metadata associated with the second data identifier.

10. The non-transitory computer readable medium of claim 8, further comprising instructions which, when executed by the at least one processor, cause the at least one processor to associate more than one data-link type with the predicted data link.

11. The non-transitory computer readable medium of claim 10, further comprising instructions which, when executed by the at least one processor, cause the at least one processor to:
generate the first candidate data-link tree according to a first data-link type; and
generate the second candidate data-link tree according to a second data-link type.

12. The non-transitory computer readable medium of claim 8, further comprising instructions which, when executed by the at least one processor, cause the at least one processor to generate, within the first candidate data-link tree and the second candidate data-link tree, a ghost node for a node connecting the first data identifier and the second data identifier, wherein the ghost node represents an unknown data identifier.

13. The non-transitory computer readable medium of claim 8, further comprising instructions which, when executed by the at least one processor, cause the at least one processor to utilize, according to the predicted data link, a first method to calculate a data-match value within a threshold and utilize a second method to calculate a data-value outside of the threshold.

14. The non-transitory computer readable medium of claim 8, further comprising instructions which, when executed by the at least one processor, cause the at least one processor to utilize a machine learning model to determine the predicted data link.

15. A system comprising:
one or more memory devices; and
one or more processors coupled to the one or more memory devices, wherein the one or more processors are configured to cause the system to:
determine, for a first data identifier and a second data identifier within a relationship cluster comprising a plurality of data identifiers grouped according to data matches, a predicted data link between the first data identifier and the second data identifier;
generate, based on the predicted data link, a first candidate data-link tree and a second candidate data-link tree, wherein the first candidate data-link tree comprises a first connection between a first node representing the first data identifier and a second node representing the second data identifier and wherein the second candidate data-link tree comprises a second connection between the first node and the second node;
calculate a first data-match value for the first candidate data-link tree and a second data-match value for the second candidate data-link tree; and
based on comparing the first data-match value and the second data-match value, generate a primary data-link tree including the first node and the second node arranged according to the first connection reflected by the first candidate data-link tree.

16. The system of claim 15, wherein the one or more processors are further configured to generate, for display with a graphical user interface of a client device, a confusion matrix, wherein the confusion matrix depicts prediction accuracy across a plurality of data-match levels by:
comparing a predicted data link between a placed node and a proband in the primary data-link tree with an actual data link between the placed node and the proband;
calculating an accuracy value for the predicted data link based on the actual data link; and
graphing the predicted data link within the confusion matrix according to data-match level and depicting the accuracy value.

17. The system of claim 16, wherein the one or more processors are further configured to:
adjust, according to the confusion matrix, how to determine the predicted data link; and
determine an adjusted predicted data link.

18. The system of claim 15, wherein the one or more processors are further configured to evaluate the primary data-link tree for double relationships, underrepresentation of infrequently occurring data links, and endogamy.

19. The system of claim 15, wherein the one or more processors are further configured to generate an alternate primary data-link tree by perturbing the first candidate data-link tree.

20. The system of claim 19, wherein the one or more processors are further configured to perturb the first candidate data-link tree by adding or removing an edge between nodes at random.
